(19) United States
(12) Patent Application Publication
(10) Pub. No.: US 2018/0115490 A1
(43) Pub. Date: Apr. 26, 2018

(54) RELAY APPARATUS AND METHOD OF RELAYING PACKETS

(71) Applicant: FUJITSU LIMITED, Kawasaki-shi (JP)

(72) Inventor: Takeshi Kawasaki, Kawasaki (JP)

(73) Assignee: FUJITSU LIMITED, Kawasaki-shi (JP)

(21) Appl. No.: 15/727,958

(22) Filed: Oct. 9, 2017

(30) Foreign Application Priority Data
Oct. 25, 2016 (JP) 2016-209053

(51) Int. Cl. H04L 12/851; H04L 12/801

(52) U.S. Cl. CPC H04L 47/2441; H04L 49/9036; H04L 47/29; H04L 47/2483

(57) ABSTRACT

A relay apparatus configured to receive, from a first communication apparatus, a first packets included in a first flow and a second packets included in a second flow, transmit, as a third flow, a third packets to a second communication apparatus, store a first correspondence relationship between a first sequence number in the first flow assigned to each of the first packets and a third sequence number in the third flow assigned to each of the third packets, and a second correspondence relationship between a second sequence number in the second flow assigned to each to the second packets and the third sequence number, receive, from the second communication apparatus, a first notification which requests to transmit a first packet included in the third packets, determine which of the first flow and the second flow includes the first packet, and transmit a second notification to the first communication apparatus.

### CROSS-REFERENCE TO RELATED APPLICATION

This application is based upon and claims the benefit of priority of the prior Japanese Patent Application No. 2016-209053, filed on Oct. 25, 2016, the entire contents of which are incorporated herein by reference.

### FIELD

The embodiments discussed herein are related to a relay apparatus and a method of relaying packets.

### BACKGROUND

As a technique virtually handling a plurality of communication lines as a single communication line, there is a link aggregation. The link aggregation allows TCP streams to be transferred, for example, via a plurality of paths using the multi path transmission control protocol (MPTCP).

When communication is performed between a communication apparatus that supports the link aggregation and a communication apparatus that does not support the link aggregation, a packet relay apparatus capable of the protocol conversion between TCP and MPTCP has to be provided between the communication apparatuses. A storage system having a protocol conversion function is disclosed in Japanese National Publication of International Patent Application No. 2005-505037, which is one of the prior art documents.

### SUMMARY

According to an aspect of the invention, a relay apparatus configured to relay communication between a first communication apparatus and a second communication apparatus, the relay apparatus includes a memory, and a processor coupled to the memory and configured to receive, from the first communication apparatus, a first plurality of packets included in a first flow and a second plurality of packets included in a second flow, transmit, as a third flow, a third plurality of packets including the first plurality of packets and the second plurality of packets to the second communication apparatus, store, in the memory, a first correspondence relationship between a first sequence number in the first flow assigned to each of the first plurality of packets and a third sequence number in the third flow assigned to each of the third plurality of packets, and a second correspondence relationship between a second sequence number in the second flow assigned to each to the second plurality of packets and the third sequence number, receive, from the second communication apparatus, a first notification which requests to transmit a first packet included in the third plurality of packets, the first notification indicating the third sequence number assigned to the first packet, determine which of the first flow and the second flow includes the first packet based on at least one of the first correspondence relationship and the second correspondence relationship, and transmit a second notification to the first communication apparatus, the second notification indicating the first sequence number assigned to the first packet when the first packet is included in the first flow, and the second notification indicating the second sequence number assigned to the first packet when the first packet is included in the second flow.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates operations of a packet relay apparatus of a comparative example;

FIG. 2 illustrates operations of a packet relay apparatus according to the embodiment;

FIG. 3 illustrates an example of a TCP packet format;

FIG. 4 is a configuration diagram illustrating the packet relay apparatus according to the embodiment;

FIG. 5 illustrates an example of the packet management table;

FIG. 6 is a flowchart illustrating an example of processing of the data packet received from a server apparatus;

FIGS. 7A and 7B are flowcharts illustrating an example of processing of an acknowledge (ACK) packet received from a client apparatus;

FIG. 8 is a sequence diagram illustrating an example of relay processing of the data packet from the server apparatus to the client apparatus;

FIG. 9 is a sequence diagram illustrating another example of relay processing of the data packet from the server apparatus to the client apparatus;

FIG. 10 is a flowchart illustrating an example of processing of the data packet received from the client apparatus;

FIG. 11 is a flowchart illustrating an example of processing of the ACK packet received from the server apparatus;

FIG. 12 is a sequence diagram illustrating an example of relay processing of the data packet from the client apparatus to the server apparatus;

FIG. 13 is a sequence diagram illustrating another example of relay processing of the data packet from the client apparatus to the server apparatus;

FIG. 14 is a sequence diagram illustrating an example of transmission processing of the ACK packet from the packet relay apparatus to the client apparatus;

FIG. 15 is a configuration diagram illustrating a packet relay apparatus according to another embodiment;

FIG. 16 is a flowchart illustrating an example of an operation switching processing;

FIG. 17 is a flowchart illustrating another example of processing of the data packet received from the server apparatus;

FIGS. 18A and 18B are flowcharts illustrating an example of processing of the ACK packet received from the client apparatus;

FIG. 19 is a sequence diagram illustrating another example of relay processing of the data packet from the server apparatus to the client apparatus;

FIG. 20 is a configuration diagram illustrating a packet relay apparatus according to another embodiment;

FIG. 21 is a sequence diagram illustrating another example of relay processing of the data packet from the server apparatus to the client apparatus; and

FIG. 22 is a sequence diagram illustrating another example of relay processing of the data packet from the server apparatus to the client apparatus.

### DESCRIPTION OF EMBODIMENTS

The packet relay apparatus retransmits a packet to a communication section of TCP or communication section of MPTCP in response to a packet loss notification from respective communication apparatuses. Thus, the packet relay apparatus requests to have a buffer of a large capacity for temporarily storing packets until normal reception of the packet is confirmed. This hinders cost-down and downsizing of the packet relay apparatus.

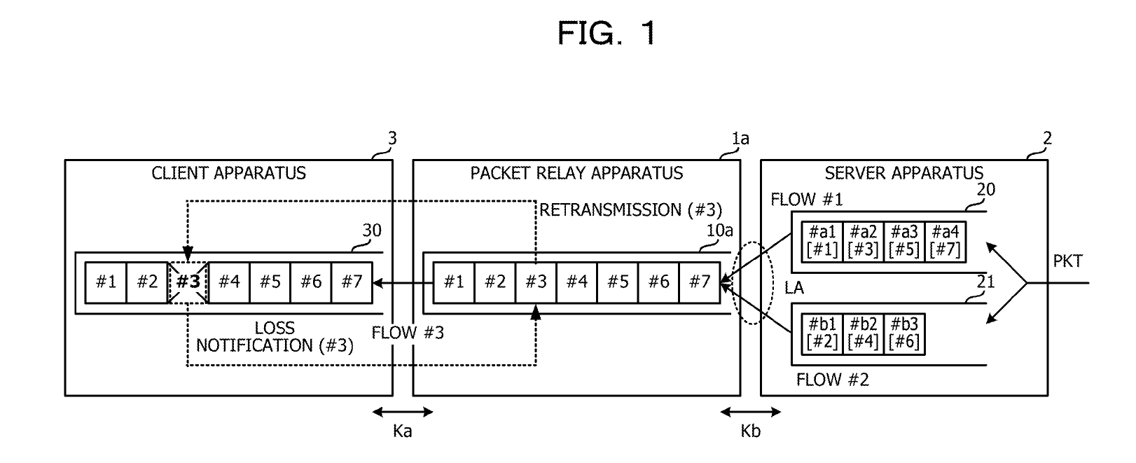

FIG. 1 illustrates operations of a packet relay apparatus 1a of a comparative example. The packet relay apparatus 1a is, for example, a layer 2 switch that is configured to relay a packet from a server apparatus 2 to a client apparatus 3. The client apparatus 3 includes, for example, terminal devices such as a personal computer, but is not limited thereto.

The packet relay apparatus 1a is coupled with the server apparatus 2 via, for example, two communication lines LA bundled by the link aggregation. The packet relay apparatus 1a receives packets of a flow #1 via one communication line, and receives packets of a flow #2 via another communication line. Flows #1 and #2 are packet streams determined by a transmission source internet protocol (IP) address and a transmission source port number of the packet.

The packet relay apparatus 1a and the server apparatus 2 communicate with each other based on, for example, the MPTCP. Namely, the MPTCP is used for communication in a section Kb between the packet relay apparatus 1a and the server apparatus 2.

The packet relay apparatus 1a is also coupled with the client apparatus 3 via one communication line. The packet relay apparatus 1a transmits packets of a flow #3 via the communication line. The packet relay apparatus 1a and the client apparatus 3 communicate with each other based on, for example, the TCP. Namely, the TCP is used for communication in a section Ka between the packet relay apparatus 1a and the client apparatus 3. The type of communication lines include, for example, a 10GBASE-SR, but is not limited thereto. In this embodiment, the client apparatus 3 does not support link aggregation.

The server apparatus 2 stores packets received from a network upstream thereof (see PKT) or packets generated by an application in the server apparatus 2 separately into transmission buffers 20, 21 of two communication lines. In this embodiment, 10 packets are stored into buffers 20, 21 for each of flows #1, #2. By way of example, 4 packets of the flow #1 are stored in one buffer 20, and 3 packets of the flow #2 are stored in another buffer 21.

An area of the sequence number in a TCP header of packets of the flow #1 is assigned with sequence numbers #a1 to #a4 (positive integer) in the flow #1. Packets of the flow #1 are also assigned with sequence numbers #1, #3, #5, #7 in the flow #3 corresponding to sequence numbers #a1 to #a4. For the TCP communication in the section Kb, sequence numbers #a1 to #a4 in the flow #1 are used.

An area of the sequence number in the TCP header of packets of the flow #2 is assigned with sequence numbers #b1 to #b3 (positive integer) in the flow #2. Packets of the flow #2 are also assigned with sequence numbers #2, #4, #6 in the flow #3 corresponding to sequence numbers #b1 to #b3. For the TCP communication in the section Kb, sequence numbers #b1 to #b3 in the flow #2 are used.

The server apparatus 2 sequentially reads packets from buffers 20, 21 and transmits to the packet relay apparatus 1a. The packet relay apparatus 1a converts packets received from the server apparatus 2 to packets of the flow #3 and transmits to the client apparatus 3. Then, the server apparatus 2 stores packets into a buffer 10a in preparation for re-transmission. An area of the sequence number in the TCP header of packets is assigned with sequence numbers #1 to #10 in the flow #3 in place of sequence numbers #a1 to #a4, #b1 to b3 in the flows #1, #2.

The client apparatus 3 stores packets received from the packet relay apparatus 1a into a buffer 30. For example, when a packet of the sequence number #3 is lost, the client apparatus 3 transmits a loss notification notifying to the effect to the packet relay apparatus 1a. The loss notification includes, for example, an ACK packet including a selective acknowledgement (SACK) option of the selective acknowledgement) specified by the TCP, but it is not limited thereto. The loss notification indicates the sequence number #3 of the packet lost in the flow #3.

Upon receiving the loss notification of the packet of the sequence number #3, the packet relay apparatus 1a reads packets from the buffer 10a and retransmits to the client apparatus 3. Thus, the client apparatus 3 may receive packets of sequence numbers #1 to #7 in the flow #3.

Thus, the packet relay apparatus 1a retransmits packets in response to the loss notification from the client apparatus 3. Thus, the packet relay apparatus 1a requests to have a buffer 10a of a large capacity for temporarily storing packets until normal reception of the packet is confirmed. This hinders cost-down and downsizing of the packet relay apparatus.

Then, the packet relay apparatus according to this embodiment converts a sequence number in the flow #3 indicated in the loss notification from the TCP section Ka to a sequence number in the corresponding flow among the flows #1 and #2, and relays to the section Kb of the MPTCP. Thus, the server apparatus 2 retransmits packets based on the sequence number in the flows #1, #2 indicated in the relayed loss notification, and thus the packet relay apparatus is allowed not to perform retransmission processing. Consequently, the buffer 10a for re-transmission may be removed from the packet relay apparatus.

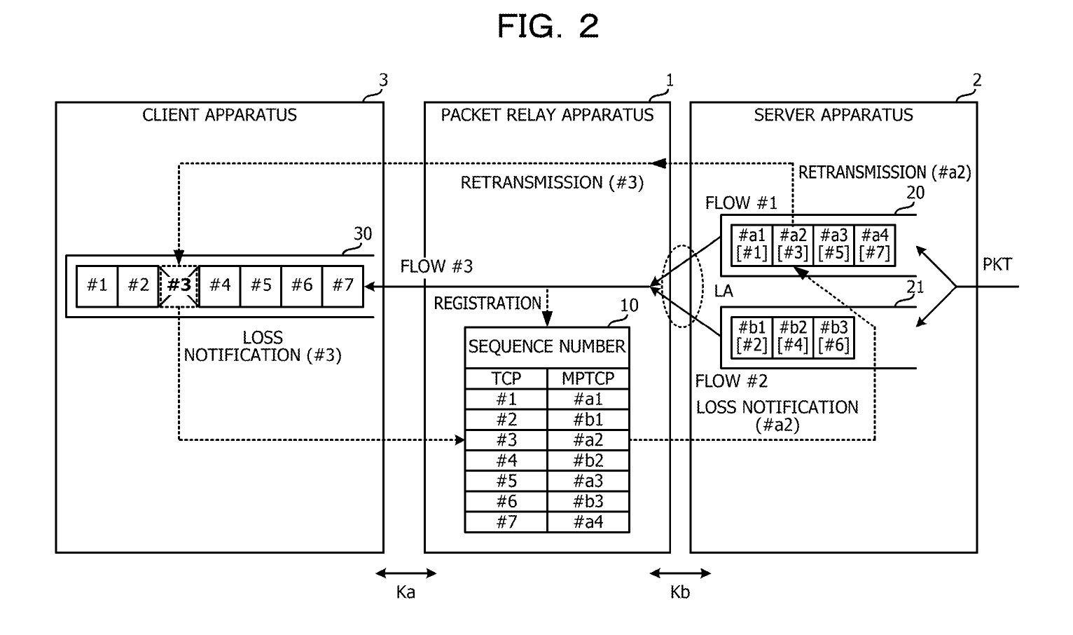

FIG. 2 illustrates operations of a packet relay apparatus 1 according to this embodiment. In FIG. 2, configurations common to FIG. 1 are assigned with same reference numerals, and description thereof is omitted.

The packet relay apparatus 1 does not include the buffer 10a for retransmission and includes a packet management table 10 indicating the correspondence relationship between sequence numbers of sections Ka and Kb. The packet management table 10 registers the sequence number of the TCP in the section Ka and the sequence number of the MPTCP in the section Kb by associating with each other. The packet management table 10 is an example of a table and is stored in a storage device such as a memory.

The packet relay apparatus 1 acquires sequence numbers in flows #1 to #3 from packets received from the server apparatus 2 and registers into the packet management table 10. Namely, the packet management table 10 registers a correspondence relationship between the sequence number in the flow #1 assigned to packets of the flow #1 and the sequence number in the flow #3, and a correspondence relationship between the sequence number in the flow #2 assigned to packets of the flow #2 and the sequence number in the flow #3.

The packet relay apparatus 1 receives the loss notification of the sequence number #3 of the packet lost in the flow #3 from the client apparatus 3. The packet relay apparatus 1 searches the packet management table 10 for the sequence number #a2 in the flow #1 corresponding to the sequence number #3 in the flow #3 indicated by the loss notification.

The packet relay apparatus 1 generates a loss notification indicating the sequence number #a2 in the flow #1 obtained from the search result and transmits to the server apparatus 2. Upon receiving the loss notification from packet relay apparatus 1, the server apparatus 2 reads packets of the sequence number #a2 from the buffer 20 according to the sequence number #a2 indicated by the loss notification, and retransmits. The packet relay apparatus 1 relays the retransmitted packets to the client apparatus 3.

Thus, the packet relay apparatus 1 converts the sequence number of the loss notification received from the client apparatus 3 and relays to the server apparatus 2. The server apparatus 2 retransmits the packet according to the sequence number indicated by the loss notification relayed from the packet relay apparatus 1. Consequently, the buffer 10a for re-transmission may be removed from the packet relay apparatus 1. In this embodiment, the packet is relayed from the server apparatus 2 to the client apparatus 3. However, the above operation is performed in the same manner even when the packet is relayed from the client apparatus 3 to the server apparatus 2.

In this embodiment, a TCP packet is used as the packet. The TCP packet includes a data packet storing data as payload and an ACK packet as acknowledge used for reception confirmation of the data packet. The data packet is an example of the packet, and the ACK packet is an example of the sequence number notification of the lost data packet.

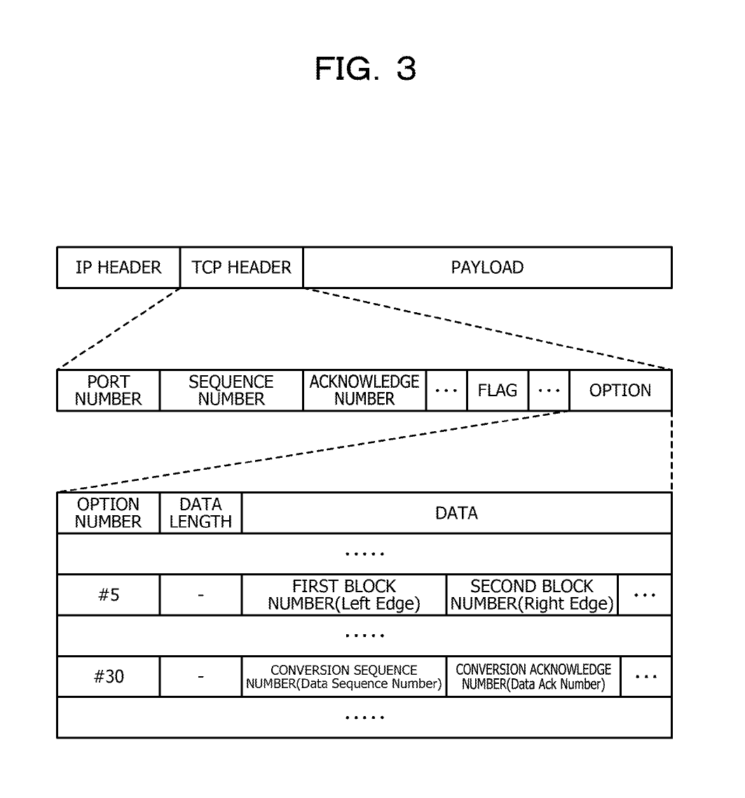

FIG. 3 illustrates an example of a TCP packet format. The TCP packet includes an IP header including a transmission source IP address and a destination IP address, a TCP header, and a payload. The TCP header includes a port number, a sequence number, an acknowledge number, a flag area, and an optional area.

The port number includes a destination port number and a transmission source port number. The sequence number is a sequence number in flows #1 to #3 of the data packet. In the above example, a sequence number out of sequence numbers #a1 to #a4 in the flow #1 or a sequence number out of sequence numbers #b1 to #b3 in the flow #2 is set as the sequence number of the data packet in the section Kb. A sequence number out of sequence numbers #1 to #7 in the flow #1 is set as the sequence number of the data packet in the section Ka.

A value of the sequence number of the data packet of the acknowledge target plus a size of the data packet thereof is set as the acknowledge number. The flag area includes a type indicator of the TCP packet. For example, ACK flag of the ACK packet is represented by “1”.

The optional area includes an option number, a data length, and various data. Data of the option number #5 is used for SACK of the selective acknowledge. In this embodiment, the sequence number of the lost data packet is detected based on a range of the sequence number of the normally received data packet indicated by SACK.

More specifically, data of the SACK includes a first block number (left edge) and a second block number (right edge). The left edge is a sequence number of the data packet that comes in the first place after lack of the sequence number. The right edge is a sequence number of the data packet that is expected to come next. The packet relay apparatus 1 detects the sequence number of the lost data packet from the left edge.

Data of an option number #30 is used for conversion of the sequence number and acknowledge number. More specifically, data of the option number #30 includes a conversion sequence number (data sequence number) and a conversion acknowledge number (data ack number). In the above example, sequence numbers #1 to #7 in the flow #3 are set to the data sequence number of data packets in the section Kb.

For example, data packets of the sequence number #a1 in the flow #1 are assigned with the sequence number #1 in the flow #3 as the data sequence number. Data packets of the sequence number #b1 in the flow #2 are assigned with the sequence number #2 in the flow #3 as the data sequence number. With the data sequence number set to the sequence number, the packet relay apparatus 1 converts data packets in the flow #1 and data packets in the flow #2 into data packets of the flow #3, and transmits to the client apparatus 3. When relaying data packets from the client apparatus 3 to the server apparatus 2, the packet relay apparatus 1 assigns a sequence number in flows #1, #2 into the data packets, sets the assigned sequence number to the data sequence number, and transmits the data packets.

The data ack number is a value of a converted acknowledge number. In the above example, with the conversion acknowledge number set to the acknowledge number, the packet relay apparatus 1 converts data packets in the flow #1 and data packets in the flow #2 into data packets of the flow #3, and transmits to the client apparatus 3. When relaying data packets from the client apparatus 3 to the server apparatus 2, the packet relay apparatus 1 assigns a sequence number in flows #1, #2 into the data packets, sets an acknowledge number corresponding to the assigned sequence number to the data ack number, and transmits the data packets.

Next, configuration of the packet relay apparatus 1 is described. In the description below, a direction from the client apparatus 3 toward the server apparatus 2 is represented by “uplink”, and a direction from the server apparatus 2 toward the client apparatus 3 is represented by “downlink”. FIG. 2 illustrates downlink flows #1 to #3 only. However, uplink flows #1 to #3 that are transmission directions reverse to the downlink also exist. In the downlink relay processing, each of flows #1 to #3 is an example of first to third flows respectively. In the uplink relay processing, each of flows #1 to #3 is an example of the fifth flow, sixth flow, and fourth flow respectively.

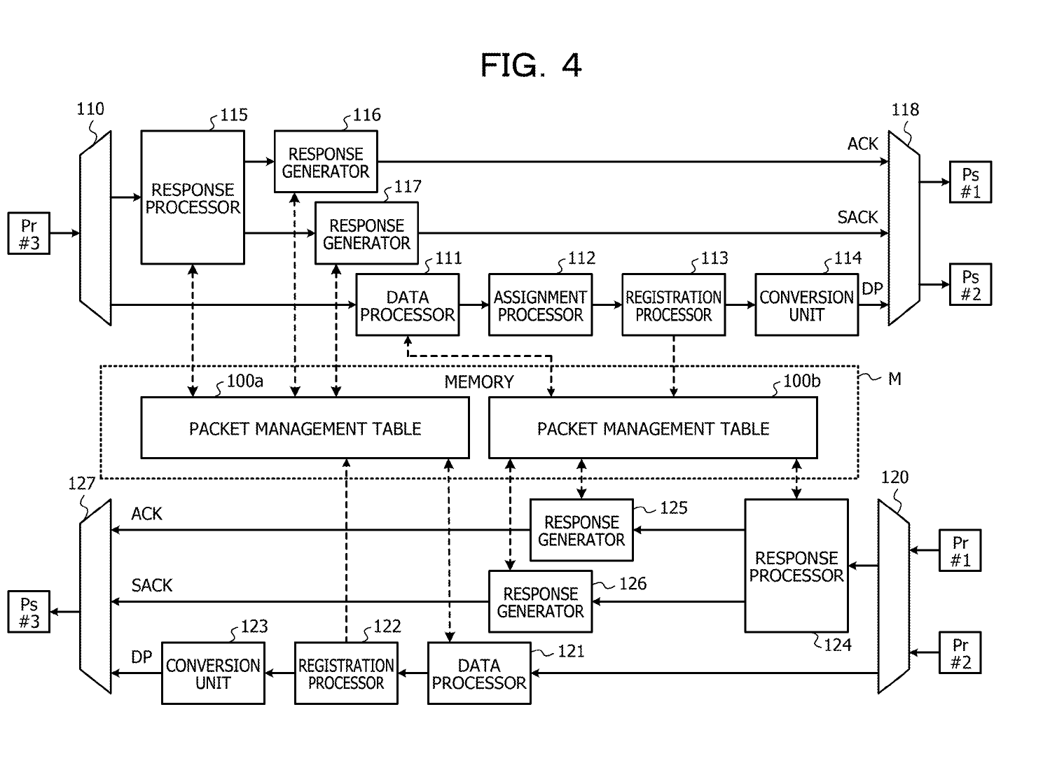

FIG. 4 illustrates a configuration diagram of a packet relay apparatus 1 of this embodiment. The packet relay apparatus 1 includes transmission ports Ps #1 to #3, reception ports Pr #1 to #3, separation units 110, 120, multiplexers 118, 127, data processors 111, 121, an assignment processor 112, registration processors 113, 122, and conversion units 114, 123. Further, the packet relay apparatus 1 includes response processors 115, 124, response generators 116, 117, 125, 126, and a memory M.

Components 110 to 118, 120 to 127 are configured by, for example, a software function driving a central processing unit (CPU), or a field programmable gate array (FPGA) or an application specific integrated circuit (ASIC).

The memory M stores packet management tables 100a, 100b. The packet management table 100a registers the correspondence relationship of sequence numbers of data packets relayed in the downward direction, and the packet management table 100b registers the correspondence relationship of sequence numbers of data packets relayed in the upward direction. The memory M is an example of a storage unit that stores packet management tables 100a, 100b. A hard disk drive may be used as a storage unit.

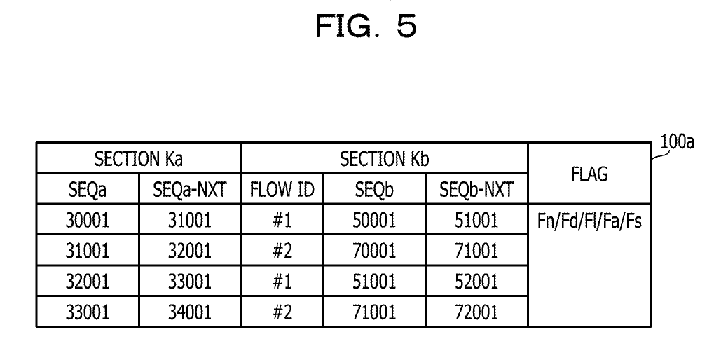

FIG. 5 illustrates an example of the packet management table 100a. The packet management table 100a registers the correspondence relationship between the sequence number SEQa (or sequence number in the flow #3) of the section Ka and the sequence number SEQb (or sequence number in flows #1, #2) of the section Kb. The packet management table 100a registers a flow ID for identifying flows #1, #2 of the section Kb.

For example, “30001” being the sequence number SEQa of the section Ka corresponds to “50001” being the sequence number SEQb of the section Kb. Namely, data packets of the sequence number “50001” in the flow #1 are transmitted after being converted to data packets of the sequence number “30001” in the flow #3.

Also, “31001” being the sequence number SEQa of the section Ka corresponds to “70001” being the sequence number SEQb of the section Kb. Namely, data packets of the sequence number “70001” in the flow #2 are transmitted after being converted to data packets of the sequence number “31001” in the flow #3.

The packet management table 100a also registers a sequence number SEQa-NXT next to the sequence number SEQa and a sequence number SEQb-NXT next to the sequence number SEQb. The packet relay apparatus 1 detects, for example, loss of the data packet based on sequence numbers SEQa-NXT, SEQb-NXT.

The packet management table 100a registers flags Fn, Fd, FI, Fa, Fs for each of sequence numbers SEQa, SEQb. The flag Fn indicates that the data packet is transmitted and the ACK packet thereof is not yet received. The Flag Fd indicates that the data packet is lost. The flag Fl indicates that loss of the data packet has been notified by the ACK packet. The flag Fa indicates that the data packet has been transmitted and the ACK packet thereof has been received. Fs indicates that ACK packet of the SACK of the data packet has been transmitted.

The packet relay apparatus 1 manages state of the data packet by the flag for each of sequence numbers. In this example, configuration of the packet management table 100a is described. However, the packet management table 100b also includes the same configuration.

Referring back to FIG. 4, transmission ports Ps #1 to #3 include, for example, a modulator and a laser diode, and transmits the TCP packet. The transmission port Ps #1 transmits the TCP packet of the flow #1 to the server apparatus 2, and the transmission port Ps #2 transmits the TCP packet of the flow #2 to the server apparatus 2. The transmission port Ps #3 transmits the TCP packet of the flow #3 to the client apparatus 3.

Reception ports Pr #1 to #3 include, for example, a demodulator and a photodiode, and receives the TCP packet. The reception port Pr #1 receives the TCP packet of the flow #1 from the server apparatus 2, and the reception port Pr #2 receives the TCP packet of the flow #2 from the server apparatus 2. The reception port Pr #3 receives the TCP packet of the flow #3 from the client apparatus 3.

Reception ports Pr #1, #2 receive the downlink TCP packet transmitted from the server apparatus 2. Reception ports Pr #1, #2 receive data packets of the flow #1 and data packets of the flow #2 as an example of the packet receiving unit in the downlink relay processing. Reception ports Pr #1, #2 receive the downlink ACK packet with respect to uplink data packets. Namely, reception ports Pr #1, #2 receive the ACK packet notifying the sequence number of the data packet lost in the flow #1 or flow #2 as an example of a notification receiving unit in the relay processing of uplink data packets. Further, some ACK packets notify the sequence number of the normally received data packet as well.

The TCP packet received by reception ports Pr #1, #2 is inputted into the separation unit 120. The separation unit 120 determines the type of the TCP packet based on, for example, existence or non-existence of the flag area or payload area (see FIG. 3), outputs data packets to the data processor 121, and outputs the ACK packet to the response processor 124.

The data processor 121 performs various processing for the data packet. The data processor 121 acquires the flow ID and sequence number of the data packet. The flow ID is identified from, for example, the number (#2, #3) of reception ports Pr #2, #3 of the reception source, the IP address of the data packet, and the port number. The sequence number is acquired from the TCP header of the data packet.

The data processor 121 searches the packet management table 100a based on the flow ID and sequence number. The data processor 121 determines from the search result whether the sequence number of the data packet is registered, and depending on the determination result, instructs the registration processor 122 to register the sequence number.

In a case where the sequence number is not registered as the search result, the data processor 121 determines based on, for example, the sequence number SEQb-NXT of the packet management table 100a, whether the data packet is lost. Namely, the data processor 121 detects loss of the data packet from lack of the consecutiveness of the sequence number in flows #1, #2 of the data packet. If the data packet is lost, the data processor 121 instructs the registration processor 122 to register the sequence number of the lost data packet.

Thus, as an example of the detection unit, the data processor 121 detects loss of the data packet based on the sequence number in the flow #1 or the sequence number in the flow #2 assigned to the data packet received by reception ports Pr #2.

The registration processor 122 registers the sequence number of the data packet into the packet management table 100a in accordance with the instruction of the data processor 121. More specifically, the registration processor 122 acquires the data sequence number from the optional area of the data packet and registers the correspondence relationship between the sequence number and the conversion sequence number. Thus, the correspondence relationship between the sequence number in flows #1, #2 of the received data packet and the sequence number in the flow #3 is registered. In this operation, the registration processor 122 also registers the flow ID into the packet management table 100a.

When the data processor 121 detects loss of the data packet, the registration processor 122 registers the correspondence relationship between the sequence number in flows #1, #2 assigned to the data packet and the sequence number in the flow #3 into the packet management table 100a. Thus, the correspondence relationship between the sequence number in flows #1, #2 of the lost data packet and the sequence number in the flow #3 is registered. In this operation, the registration processor 122 also registers the flow ID into the packet management table 100a.

The registration processor 122 generates next sequence numbers SEQa-NXT, SEQb-NXT from the sequence number and conversion sequence number of the data packet and registers into the packet management table 100a. After completion of registration, the registration processor 122 outputs the data packet to the conversion unit 123.

The conversion unit 123 converts data packets of flows #1, #2 into data packets of the flow #3. More specifically, the conversion unit 123 replaces the sequence number with the conversion sequence number and replaces the acknowledge number with the conversion acknowledge number. Thus, the sequence number and acknowledge number of flows #1, #2 are converted to the sequence number and acknowledge number of the flow #3 in the data packet. The conversion unit 123 outputs the data packets (DP) of the flow #3 into the multiplexer 127.

The multiplexer 127 time-division multiplexes the ACK packet (ACK) of acknowledge received from the response generator 125, the ACK packet (SACK) including the selective acknowledge received from the response generator 126, and the data packet (DP) received from the conversion unit 123 and outputs to the transmission port Ps #3. The transmission port Ps #3 transmits various TCP packets received from the multiplexer 127 to the client apparatus 3.

Thus, the transmission port Ps #3 and conversion unit 123 convert data packets of the flow #1 and data packets of the flow #2 into data packets of the flow #3 and transmit as an example of the packet transmission unit in the uplink relay processing of the data packet. Reception ports Pr #1, #2 receive data packets of the flow #1 and data packets of the flow #2 as an example of the receiving unit in the downlink relay processing of the data packet.

The response processor 124 performs various processing for the ACK packets received from the separation unit 120. The ACK packet is an acknowledge corresponding to the uplink data packet. The response processor 124 acquires the acknowledge number and flow ID from the ACK packet and controls the flag of the packet management table 100b based on the acknowledge number and flow ID.

The response processor 124 also determines whether there exists the SACK in the optional area of the ACK packet. In a case where the SACK exists, the response processor 124 identifies the sequence number in flows #1, #2 of the lost data packet from the left edge (see FIG. 3), and searches the packet management table 100b for the sequence number in the flow #3 corresponding to the sequence number thereof.

The response processor 124 notifies the sequence number in the searched flow #3 (sequence number in the flow #3 of the lost data packet) to the response generator 126 and instructs the response generator 126 to generate the ACK packet (SACK) of acknowledge including the SACK based on the sequence number. In a case where the SACK does not exists (no lost data packet exists), the response processor 124 converts the acknowledge number into an acknowledge number of the flow #3 based on the packet management table 100b, notifies to the response generator 125, and instructs the response generator 125 to generate the ACK packet (ACK) of multiple acknowledges based on the sequence number thereof.

Response generators 125, 126 generate the ACK packet in accordance with the instruction of the response processor 124, and output to the multiplexer 127. The response generator 125 generates the ACK packet (ACK) as an acknowledge notifying normal reception of the data packet, and the response generator 126 generates the ACK packet (SACK) including a selective acknowledge notifying loss of the data packet.

Thus, the response processor 124 searches the packet management table 100b for the sequence number in the flow #3 corresponding to a sequence number in the flow #1 indicated by the ACK packet (SACK) or a sequence number in the flow #3 corresponding to the sequence number in the flow #2, as an example of a search processor in the relay processing of the uplink data packet. The transmission port Ps #3 transmits the ACK packet notifying the sequence number searched by the response processor 124 to the client apparatus 3 that is the transmission source of data packets of the flow #3, as an example of the notification transmission unit in the relay processing of the uplink data packet.

The reception ports Pr #3 receives the uplink TCP packet transmitted from the client apparatus 3. The reception port Pr #3 receives data packets of the flow #3 as an example of the packet receiving unit in the uplink relay processing. The reception port Pr #3 receives the uplink ACK packet with respect to the data packet relayed in the downward direction. Namely, the reception ports Pr #3 receives the ACK packet notifying the sequence number of the packet lost in the flow #3 as an example of the notification receiving unit in the downlink relay processing. Some ACK packets notify the sequence number of the data packet normally received in the flow #3.

The TCP packet received by the reception port Pr #3 is inputted into the separation unit 110. The separation unit 110 determines the type of the TCP packet based on, for example, whether the flag area or payload area exists (see FIG. 3), outputs the data packet to the data processor 111, and outputs the ACK packet to the response processor 115.

The data processor 111 performs various processing for the data packet. The data processor 111 acquires the sequence number of the data packet. The sequence number is acquired from the TCP header of the data packet.

The data processor 111 searches the packet management table 100b based on the sequence number. The data processor 111 determines from the search result whether the sequence number of the data packet is registered, and depending on the determination result, instructs the assignment processor 112 to assign the flow ID and sequence number.

In a case where the sequence number is not registered as the search result, the data processor 111 determines based on, for example, the sequence number SEQa-NXT of the packet management table 100b, whether the data packet is lost. Namely, the data processor 111 detects loss of the data packet from lack of the consecutiveness of the sequence number in the flow #3 of the data packet. In a case where the data packet is lost, the data processor 111 instructs the assignment processor 112 to assign the sequence number of the lost data packet.

Thus, the data processor 111 detects loss of the data packet based on the sequence number in the flow #3 assigned to the data packet received by the reception port Pr #3.

The assignment processor 112 assigns the flow ID and sequence number to the received data packet in accordance with the instruction of the data processor 111. The assignment processor 112 also assigns the flow ID and sequence number to the lost data packet in accordance with the instruction of the data processor 111. Thus, data packets of the flow #3 are assigned to data packets of the flow #1 and data packets of the flow #2. The method of allocating the data packets is not limited.

Thus, the assignment processor 112 assigns a sequence number in the flow #1 or a sequence number in the flow #2 to packets of the flow #3. The assignment processor 112 instructs the registration processor 113 to register the assigned flow ID and sequence number.

In accordance with the instruction of the assignment processor 112, the registration processor 113 registers the correspondence relationship between the sequence number in the flow #3 assigned to data packets of the flow #3 and the sequence number in the flow #1 or the sequence number in the flow #2 assigned to the data packets into the packet management table 100b. The registration processor 113 outputs the data packet processed thereby to the conversion unit 114.

The conversion unit 114 converts data packets of the flow #3 into data packets of flows #1, #2. More specifically, the conversion unit 114 replaces the sequence number of data packets with a sequence number assigned to the data packets and replaces the acknowledge number according to the assigned sequence number. Thus, the sequence number and acknowledge number of the flow #3 are converted to the sequence number and acknowledge number of flows #1, #2 in data packets. The conversion unit 114 outputs the data packets (DP) of flows #1, #2 to the multiplexer 118.

The multiplexer 118 time-division multiplexes the ACK packet (ACK) of acknowledge received from the response generator 116, the ACK packet (SACK) including the selective acknowledge received from the response generator 117, and the data packet (DP) received from the conversion unit 114 and outputs separately to transmission ports Ps #1, #2. The multiplexer 118 outputs the data packet and ACK packet of the flow #1 to the transmission port Ps #1, and outputs the data packet and ACK packet of the flow #2 to the transmission port Ps #2. The transmission port Ps #1, #2 transmit various TCP packets received from the multiplexer 127 to the client apparatus 3.

Thus, in accordance with the assignment of the assignment processor 112, transmission ports Ps #1, #2 and conversion unit 114 convert the data packet of the flow #3 into the data packet of the flow #1 and data packet of the flow #2 and transmit, as an example of the packet transmission unit in the uplink relay processing of the data packet.

The response processor 115 performs various processing for the ACK packets received from the separation unit 110. The ACK packet is an acknowledge corresponding to the downlink data packet. The response processor 115 acquires the acknowledge number from the ACK packet and controls the flag of the packet management table 100a for each of flows #1, #2 based on the acknowledge number.

The response processor 115 also determines from the optional area of the ACK packet whether there exists the SACK. In a case where the SACK exists, the response processor 115 identifies the sequence number in the flow #3 of the lost data packet from the left edge (see FIG. 3), and searches the packet management table 100a for a sequence number in flows #1, #2 corresponding to the sequence number.

The response processor 115 notifies the sequence number in the searched flows #1, #2 (sequence number in flows #1, #2 of the lost data packet) to the response generator 117 and instructs the response generator 126 to generate the ACK packet (SACK) of selective acknowledge based on the sequence number. In a case where the SACK does not exists (no lost data packet exists), the response processor 115 converts the acknowledge number into an acknowledge number of flows #1, #2 based on the packet management table 100a, notifies to the response generator 116, and instruct the response generator 116 to generate the ACK packet (ACK) of multiple acknowledges based on the sequence number.

Thus, the response processor 115 searches the packet management table 100a for a sequence number in the flow #1 corresponding to a sequence number in the flow #3 indicated by the ACK packet including SACK or a sequence number in the flow #2, as an example of a search processor in the downlink relay processing of the data packet. Transmission ports Ps #1, #2 transmit the ACK packet notifying the sequence number searched by the response processor 115 to the server apparatus 2 that is the transmission source of data packets of flows #1, #2 corresponding to the sequence number, as an example of the notification transmission unit in the downlink relay processing of the data packet.

Next, processing of the data packet and ACK packet is described. First, downlink processing is described, and then uplink processing follows.

(Downlink Processing)

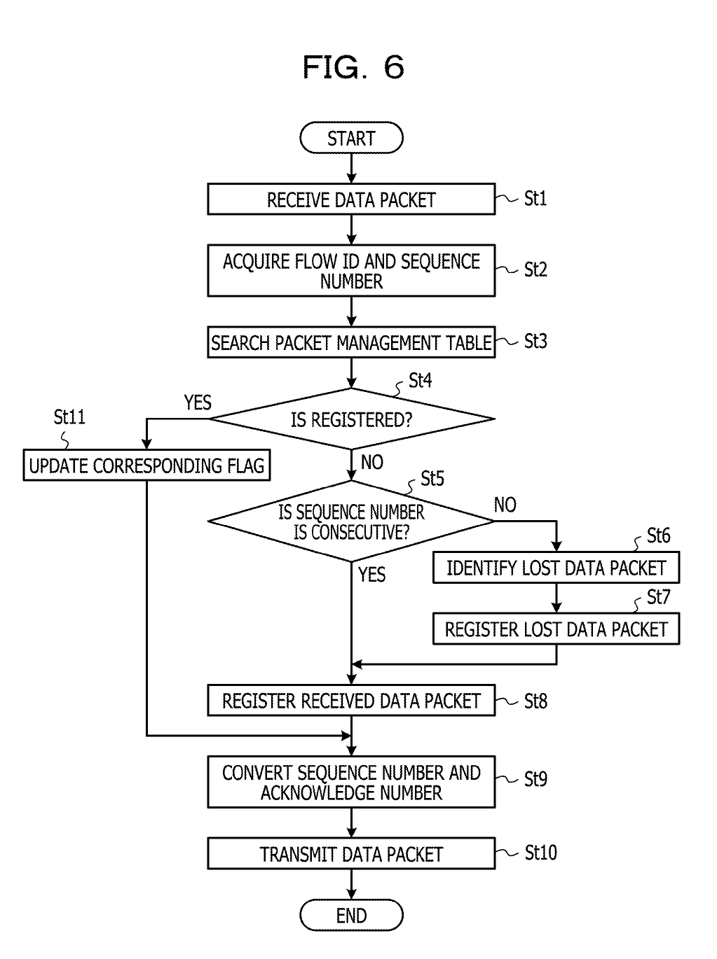

FIG. 6 is a flowchart illustrating an example of processing of the data packet received from the server apparatus 2. Reception ports Pr #1, #2 receive data packets from the server apparatus 2 via two communication lines configuring the link aggregation LA (step St1). Next, the data processor 121 acquires the flow ID of the data packet and sequence number in flows #1, #2 (step St2).

Next, the data processor 121 searches the packet management table 100a based on the flow ID and the sequence number (step St3). The data processor 121 determines whether the flow ID and sequence number have been registered in the packet management table 100a (step St4). In a case where the flow ID and sequence number have been registered (step St4: Yes), the data processor 121 determines that the received data packet is the retransmitted data packet and updates the corresponding flag of the packet management table 100a to “Fn” (step St11).

Next, the conversion unit 123 converts the sequence number and acknowledge number from values of flows #1, #2 to values of the flow #3 (step St9). Thus, data packets of flows #1, #2 are converted into data packets of the flow #3. Next, the transmission port Ps #3 transmits the data packet of the flow #3 to the client apparatus 3 (step St10).

In a case where the flow ID and sequence number are not yet registered (step St4: No), the data processor 121 determines whether the sequence number of the received data packet is consecutive to the sequence number of the previously received data packet (step St5). Thus, the data processor 121 detects loss of the data packet in flows #1, #2.

In a case where the sequence number is consecutive (step St5: Yes), the data processor 121 determines that there is no loss of the data packet, and instructs the registration processor 122 to register the sequence number. In this case, the registration processor 122 registers the sequence number in flows #1, #2 assigned to the received data packet and the sequence number in the flow #3 into the packet management table 100a (step St8). Thereafter, processing of steps St9 and St10 are performed.

In a case where the sequence number is not consecutive (step St5: No), the data processor 121 determines that the data packet is lost, and identifies the flow ID and sequence number of the lost data packet (step St6). Next, the registration processor 122 registers the flow ID and sequence number of the lost data packet into the packet management table 100a in accordance with the instruction of the data processor 121 (step: St7). In this operation, the registration processor 122 sets “Fd” to the flag.

Thus, the packet management table 100a registers not only the sequence number of normally received data packets but also the sequence number of the data packet not received by the packet relay apparatus 1 due to loss in the section Kb.

Thereafter, processing of steps St8 to St10 are performed. Thus, processing of the data packet are performed.

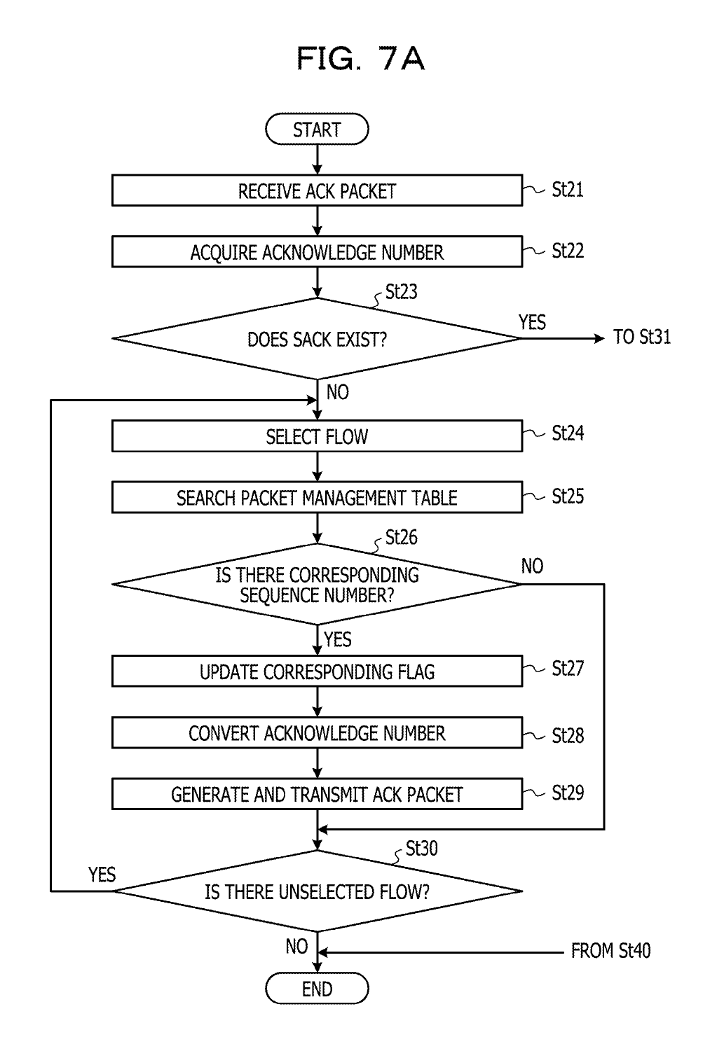

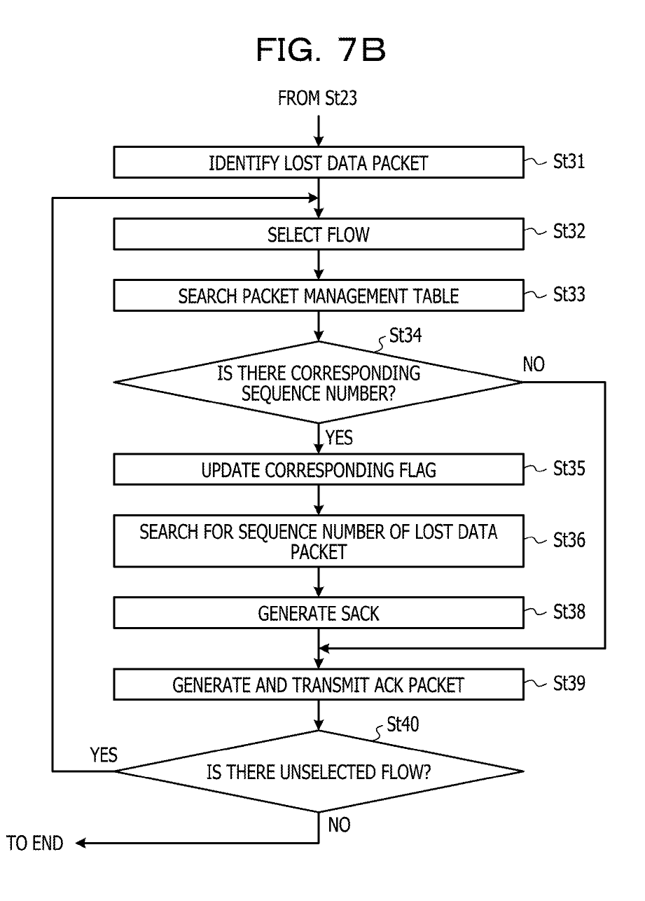

FIGS. 7A and 7B are flowcharts illustrating an example of processing of the ACK packet received from the client apparatus 3. The reception port Pr #3 receives the ACK packet from the client apparatus 3 (step St21).

The response processor 115 acquires the acknowledge number from the TCP header of the ACK packet (step St22). Next, the response processor 115 determines from the optional area of the ACK packet whether there exists the SACK (step St23).

In a case where the SACK does not exist (step St23: No), the response processor 115 determines that the ACK packet is acknowledge, and selects either one of flows #1, #2 (step St24). Subsequent processing are performed for the flow #1 or #2 selected in step St24.

Next, the response processor 115 searches the packet management table 100a for the sequence number of the ACK packet for the sequence number of the selected flow #1 or #2 (step St25). In a case where the corresponding sequence number does not exist (step St26: No), the response processor 115 performs a processing of step St30 described below.

In a case where there exists the corresponding sequence number (step St26: Yes), the response processor 115 updates the corresponding flag to “Fa” (step St27). Next, referring to the packet management table 100a, the response generator 116 converts the acknowledge number of the ACK packet into a value of the selected flow #1 or #2 (step St28). Next, the response generator 116 generates the ACK packet including the acknowledge number and transmits from the transmission port Ps #1 or #2 corresponding to the selected flow #1 or #2 (step St29).

Next, the response processor 115 determines whether there exists an unselected flow #1 or #2 (step St30). In a case where there exists no unselected flow #1 or #2 (step St30: No), the response processor 115 ends the processing. In a case where there exists an unselected flow #1 or #2 (step St30: Yes), the response processor 115 selects another flow #1 or #2 in step St24, and performs processing of step St25 and subsequent steps.

In a case where there exists the SACK (step St23: Yes), the response processor 115 identifies the sequence number of the lost data packet from the left edge of the optional area (step St31). In this operation, the response processor 115 updates the flag of the packet management table 100a to “Fa” for the sequence number of the data packet whose reception may be confirmed from the left edge.

Next, the response processor 115 selects either one of flows #1, #2 (step St32). Subsequent processing are performed on the flow #1 or #2 selected in step St32.

Next, the response processor 115 searches the packet management table 100a for the sequence number of the lost data packet for the sequence number of the selected flow #1 or #2 (step St33). In a case where there exists no corresponding sequence (step St34: No), the response generator 116 generates the ACK packet (ACK) for acknowledging a data packet of the selected flow #1 or #2 whose reception has been confirmed, and transmits from the transmission port Ps #1 or #2 corresponding to the selected flow #1 or #2 to the server apparatus 2 (step St39).

In a case where there exists the corresponding sequence number (step St34: Yes), the response processor 115 updates the corresponding flag of the packet management table 100a to “Fd” (step St35). Next, the response processor 115 searches the packet management table 100a for the sequence number in flows #1, #2 corresponding to the sequence number of the lost data packet (step St36). Thus, the sequence number of the lost data packet in flows #1, #2 is converted into the sequence number in the flow #3.

Next, the response generator 117 generates a selective acknowledge for notifying the sequence number (step St38). More specifically, the response generator 117 generates a left edge and a right edge illustrated in FIG. 3. Next, the response generator 117 generates the ACK packet (SACK) including the selective acknowledge and transmits from the transmission port Ps #1 or #2 corresponding to the selected flow #1 or #2 to the server apparatus 2 (step St39). Thus, the sequence number of the lost data packet is notified to the server apparatus 2, and thereby the lost data packet is retransmitted from the server apparatus 2.

Next, the response processor 115 determines whether there exists an unselected flow #1 or #2 (step St40). In a case where there exists no unselected flow #1 or #2 (step St40: No), the response processor 115 ends the processing. In a case where there exists an unselected flow #1 or #2 (step St40: Yes), the response processor 115 selects another flow #1 or #2 in step St32, and performs processing of step St33 and subsequent steps. Thus, processing of the ACK packet are performed.

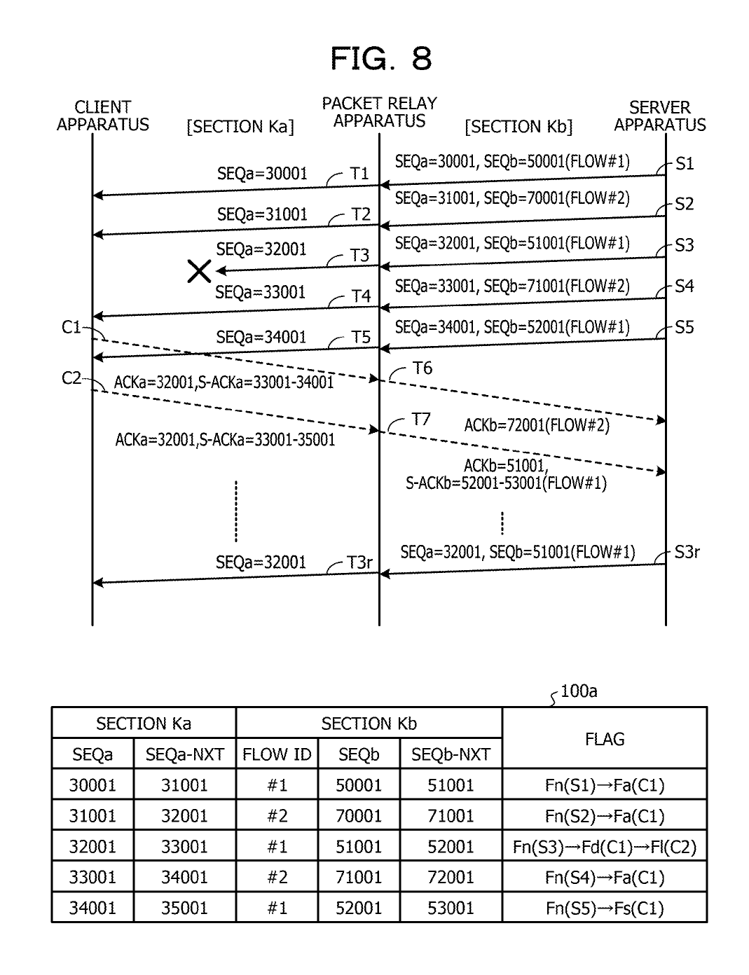

FIG. 8 is a sequence diagram illustrating an example of relay processing of the data packet from the server apparatus 2 to the client apparatus 3. In FIG. 8, flow of the data packet is indicated with solid line arrows, and flow of the ACK packet is indicated with broken line arrows. FIG. 8 also illustrates the content registered in the packet management table 100a in the relay processing.

In FIG. 8, the sequence number SEQa is a sequence number in the flow #3 assigned to the data packet, and the sequence number SEQb is a sequence number in flows #1, #2 assigned to the data packet. ACK-a is an acknowledge number assigned to the ACK packet of the flow #3, and S-ACKa is a left edge and right edge of the selective acknowledge assigned to the ACK packet of the flow #3. ACKb is an acknowledge number of the ACK packet of the flow #2.

As indicated by reference numerals S1 to S5, the server apparatus 2 alternately transmits data packets of flows #1, #2 to the packet relay apparatus 1. In this embodiment, length of data packets is 1000 (Byte) by way of example. Data packets of the flow #1 are assigned with sequence numbers in the flow #1 “50001”, “51001”, “52001” and sequence numbers in the flow #3 “30001”, “32001”, “34001”. Data packets of the flow #2 are assigned with sequence numbers in the flow #2 “70001”, “71001”, and sequence numbers in the flow #3 “31001”, “33001”.

Upon receiving the data packet, the packet relay apparatus 1 registers the sequence number SEQa in the flow #3 assigned to the data packet and the sequence number SEQb and flow ID in flows #1, #2 into the packet management table 100a. In this operation, the packet relay apparatus 1 sets “Fn” to the flag of the packet management table 100a. A reference numeral in the sequence (S1 to S5, C1, C2) is indicated in the bracket of the flag field. At a timing when the data packet or ACK packet indicated by the reference numeral comes, the corresponding flag is updated.

As indicated with reference numerals T1 to T5, the packet relay apparatus 1 converts data packets in flows #1, #2 into data packets of the flow #3, and transmits to the client apparatus 3. Data packets of the flow #3 are assigned with sequence numbers in the flow #3 “31001” to “34001”. As indicated by the mark x, the data packet of the sequence number “32001” is lost in the section Ka.

The client apparatus 3 receives data packets excluding the data packet of the sequence number “32001”. Upon receiving the data packet of the sequence number “33001”, the client apparatus 3 detects loss of the data packet of the sequence number “32001” based on the sequence number. Thus, after receiving the data packet of the sequence number “33001”, the client apparatus 3 transmits the ACK packet including selective acknowledge to the packet relay apparatus 1 as indicated by the reference numeral C1. The ACK packet is assigned with ACKa=“32001” and ACKa=“33001-34001”.

Upon receiving the ACK packet, the packet relay apparatus 1 determines that data packets up to the sequence number “31001” are received from the ACKa=“32001”, and determines that the data packet of the sequence number “33001” is received from the S-ACKa=“33001-34001”. Here, the left edge and right edge of the S-ACKa are “33001” and “34001” respectively. Thus, the packet relay apparatus 1 detects loss of the data packet of the sequence number “32001”.

The packet relay apparatus 1 sets the flag corresponding to the sequence number “32001” to “Fd” and the flag corresponding to sequence numbers “30001”, “31001”, and “33001” to “Fa” in the packet management table 100a. The packet relay apparatus 1 also sets the flag corresponding to the sequence number “34001” to “Fs”.

By searching the packet management table 100a, the packet relay apparatus 1 determines that the sequence number “32001” in the flow #3 corresponds to the sequence number “51001” in the flow #1. As indicated by the reference numeral T6, the packet relay apparatus 1 transmits the ACK packet of the flow #2 to the server apparatus 2. As there is no loss of the data packet of the flow #2, the ACK packet of the flow #2 is acknowledge (ACK) that includes ACKb=“72001”. Upon receiving the ACK packet, the server apparatus 2 confirms reception of the data packet of the sequence number “71001” in the flow #2.

After receiving the data packet of the sequence number “34001”, the client apparatus 3 transmits the ACK packet including selective acknowledge to the packet relay apparatus 1 as indicated by the reference numeral C2. The ACK packet is assigned with ACKa=“32001” and S-ACKa=“33001-35001”.

Upon receiving the ACK packet, the packet relay apparatus 1 determines that data packets up to the sequence number “31001” has been received from the ACKa=“32001”, and determines that data packets of sequence numbers “33001” and “34001” have been received from the S-ACKa=“33001-35001”.

By searching the packet management table 100a, the packet relay apparatus 1 determines that the sequence number “32001” in the flow #3 corresponds to the sequence number “51001” in the flow #1. As indicated with the reference numeral T7, the packet relay apparatus 1 transmits the ACK packet of the flow #1 to the server apparatus 2. As there is loss of the data packet of the flow #1, the ACK packet of the flow #1 includes selective acknowledge and is assigned with ACKb=“51001” and S-ACKb=“52001-53001”. As a loss notification of the packet corresponding to the sequence number “32001” has been prepared by the ACK packet, the packet relay apparatus 1 sets the flag corresponding to the sequence number “32001” to FI” into the packet management table 100a.

Upon receiving the ACK packet, the server apparatus 2 confirms reception of data packets of sequence numbers “50001” and “52001” in the flow #1, and detects loss of the data packet of the sequence number “51001” in the flow #1. Thus, for example, upon receiving the ACK packet of the same ACK number three times from the packet relay apparatus 1, the server apparatus 2 retransmits the lost data packet of the sequence number “51001” as indicated by the reference numeral S3r.

Upon receiving the retransmitted data packet, the packet relay apparatus 1 converts the retransmitted data packet into the data packet of the flow #3 and transmits to the client apparatus 3 as indicated by the reference numeral T3r. More specifically, the transmission port Ps #3 and conversion unit 123 of the packet relay apparatus 1 converts the data packet re-transmitted from the server apparatus 2 depending on the ACK packet (reference numeral T7) transmitted by the transmission port Ps #1 into the data packet of the flow #3, and transmits. Thus, the packet relay apparatus 1 may relay the retransmitted packet to the client apparatus 3.

Thus, the packet relay apparatus 1 receives the ACK packet notifying the sequence number “32001” of the data packet lost in the flow #3 from the client apparatus 3, and searches the packet management table 100a for a sequence number in the flow #1 corresponding to the sequence number thereof. The packet relay apparatus 1 transmits the ACK packet notifying the searched sequence number to the server apparatus 2 of transmission source of the data packet of the flow #1.

Thus, the server apparatus 2 may retransmit the lost data packet to the packet relay apparatus 1, and the packet relay apparatus 1 may transmit the retransmitted data packet to the client apparatus 3. Consequently, the buffer for retransmitting the data packet may be removed from the packet relay apparatus 1.

In this embodiment, loss of the data packet occurs in the section Ka. However, the above operation is performed in the same manner even when loss of the data packet occurs in the section Kb.

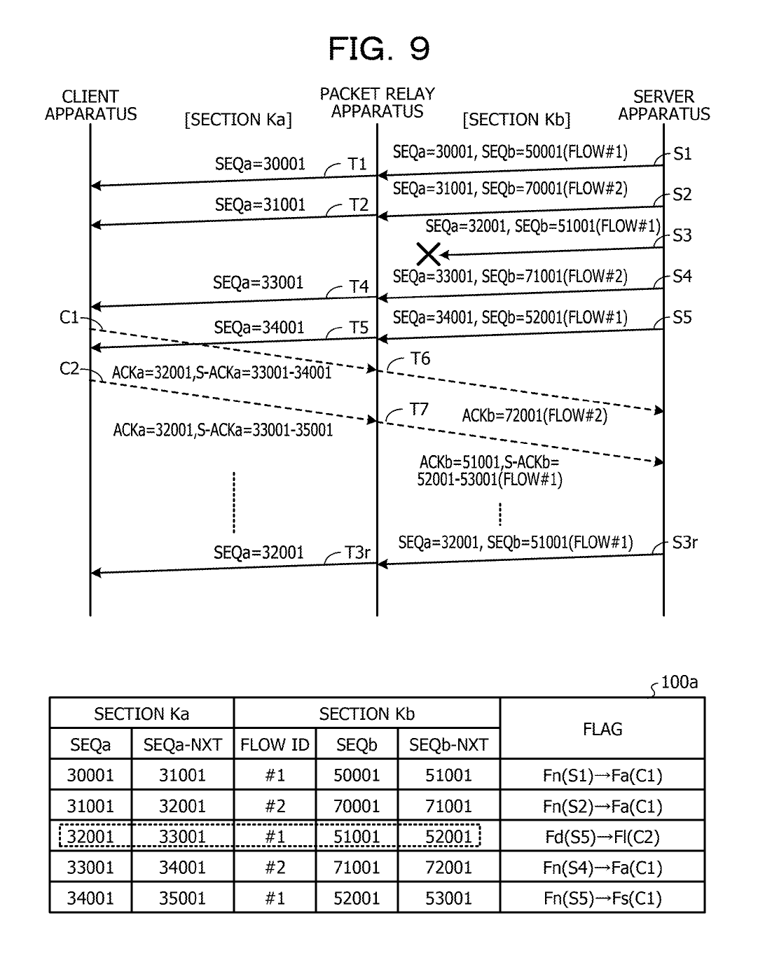

FIG. 9 is a sequence diagram illustrating another example of relay processing of the data packet from the server apparatus 2 to the client apparatus 3. In FIG. 9, matters common to FIG. 8 are assigned with same reference numerals, and description thereof is omitted.

In this embodiment, the data packet of the sequence number “51001” in the flow #1 is lost in the section Kb as indicated by the mark x. The packet relay apparatus 1 detects loss of the data packet from lack of the consecutiveness of the sequence number of the data packet received from the server apparatus 2.

More specifically, upon receiving a data packet next to the lost data packet, the packet relay apparatus 1 detects loss of the data packet from lack of a sequence number between a sequence number of the next data packet and a sequence number of the previously received data packet. The packet relay apparatus 1 registers the correspondence relationship between the sequence number in the flow #1 assigned to the lost data packet and the sequence number in the flow #3 into the packet management table 100a (see dotted line frame). The packet relay apparatus 1 also sets the corresponding flag to “Fd”.

Thus, the packet relay apparatus 1 also registers the data packet lost before receiving from the server apparatus 2 into the packet management table 100. Thus, the packet relay apparatus 1 may search the packet management table 100a for the sequence number of the lost data packet in the same manner as the above example, and notify to the server apparatus 2. In this embodiment, the data packet of the flow #1 is lost. However, the same operation as the above is also performed even when the data packet of the flow #2 is lost.

As described above, the packet relay apparatus 1 includes reception ports Pr #1 to #3, the conversion unit 123, transmission ports Ps #1 to #3, the memory M, and the response processor 115. Reception ports Pr #1, #2 receive data packets of the flow #1 and data packets of the flow #2. The transmission port Ps #3 and conversion unit 123 convert data packets of the flow #1 and data packets of the flow #2 into data packets of the flow #3 and transmit.

The memory M stores the packet management table 100a. The packet management table 100 registers the correspondence relationship between the sequence number in the flow #1 assigned to data packets of the flow #1 and the sequence number in the flow #3, and the correspondence relationship between the sequence number in the flow #2 assigned to data packets of the flow #2 and the sequence number in the flow #3.

The reception ports Pr #1, #2 receive the ACK packet notifying the sequence number of the packet lost in the flow #3. The response processor 115 searches the packet management table 100a for a sequence number in the flow #1 corresponding to the sequence number in the flow #3 indicated by the ACK packet or a sequence number in the flow #2. Transmission ports Ps #1, #2 transmit the ACK packet notifying loss of the data packet of the sequence number searched by the response processor 115 to the server apparatus 2 that is the transmission source of data packets of flows #1, #2 corresponding to the sequence number thereof.

Thus, the packet relay apparatus 1 may notify the sequence number of the lost data packet in the flow #1 or #2 to the server apparatus 2. As the server apparatus 2 retransmits the data packet depending on the notification from the packet relay apparatus 1, the buffer for storing the data packet for retransmission may be removed from the packet relay apparatus 1. Consequently, the buffer is removed from the packet relay apparatus 1.

The packet relay apparatus 1 includes the memory M for storing the packet management tables 100a, 100b in place of the buffer of the data packet. However, capacity requested for the memory M is smaller than the buffer of the data packet. Since length of the data packet is 1500 (byte) at most, 1500 (byte) is requested for one data packet as the buffer capacity.

In the meantime, the capacity of 32 (bit) at most is enough for each of items (SEQa, SEQb, flow ID, and flag) of the packet management tables 100a, 100b. Thus, the capacity of the packet management tables 100a, 100b is approximately 20 (byte) (=32×5 items) for one data packet. Consequently, the capacity of the memory M is reduced to 1/75 (=20/1500) compared to the case where the buffer of the data packet is used.

(Uplink Processing)

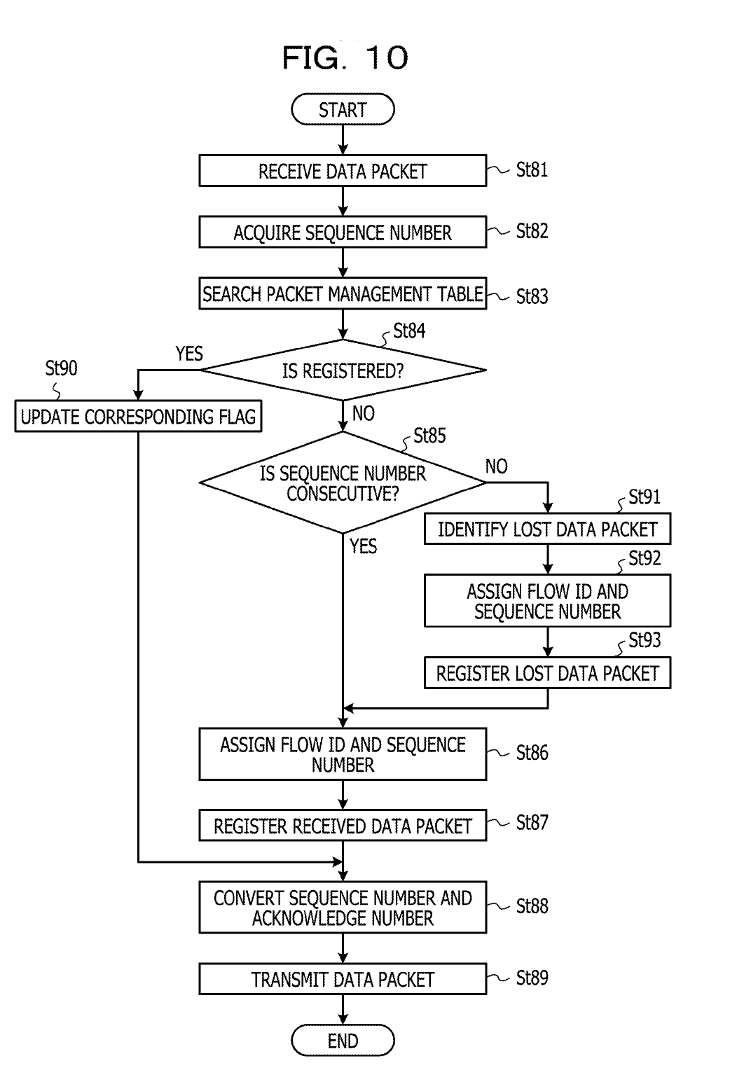

FIG. 10 is a flowchart illustrating an example of processing of the data packet received from the client apparatus 3. The reception port Pr #3 receives data packets from the server apparatus 2 via a communication line (step St81). The data processor 111 acquires the sequence number of the data packet in the flow #3 (step St82).

Next, the data processor 111 searches the packet management table 100b based on the sequence number (step St83). The data processor 111 determines whether the sequence number has been registered in the packet management table 100b (step St84). In a case where the sequence number has been registered (step St84: Yes), the data processor 111 determines that the received data packet is the retransmitted data packet and updates the corresponding flag of the packet management table 100b to “Fn” (step St90).

Next, the conversion unit 114 converts the sequence number and acknowledge number from the value of the flow #3 to the value of flows #1, #2 (step St88). Thus, data packets of the flow #3 are converted into data packets of flows #1, #2. Next, transmission ports Ps #1, #2 transmit data packets of flows #1, #2 to the client apparatus 3 (step St89).

In a case where the sequence number is not yet registered (step St84: No), the data processor 111 determines whether the sequence number of the received data packet is consecutive to the sequence number of the previously received data packet (step St85). Thus, the data processor 121 detects loss of the data packet in the flow #3.

In a case where the sequence number is consecutive (step St85: Yes), the data processor 111 determines that there is no loss of the data packet, and instructs the assignment processor 112 to assign the flow ID and sequence number. In this case, the assignment processor 112 assigns the flow ID and the sequence number in flows #1, #2 to data packets (step St86). Next, the registration processor 113 registers the sequence number in the flow #3 assigned to the received data packet and the sequence number in the flow #1 or #2 assigned to the received data packet into the packet management table 100b (step St87). Thereafter, processing of steps St88 and St89 are performed.

In a case where the sequence number is not consecutive (step St85: No), the data processor 111 determines that there is loss of the data packet, and identifies the sequence number of the lost data packet (step St91). Next, the assignment processor 112 assigns the flow ID and sequence number thereof in flows #1, #2 to the lost data packet (step St92). Next, the registration processor 113 registers the sequence number in the flow #3 assigned to the lost data packet and the flow ID and sequence number assigned to the lost data packet into the packet management table 100b in accordance with the instruction of the data processor 111 (step: St93). In this operation, the registration processor 122 sets “Fd” to the flag.

Thus, the packet management table 100b registers not only the sequence number of the normally received data packet but also the sequence number of the data packet not received by the packet relay apparatus 1 due to loss in the section Ka. Consequently, when received the ACK packet notifying the sequence number of the lost data packet, the packet relay apparatus 1 may convert the sequence number indicated by the ACK packet into the sequence number in the flow #3.

Thereafter, processing of steps St86 to St89 are performed. Thus, processing of the data packet are performed.

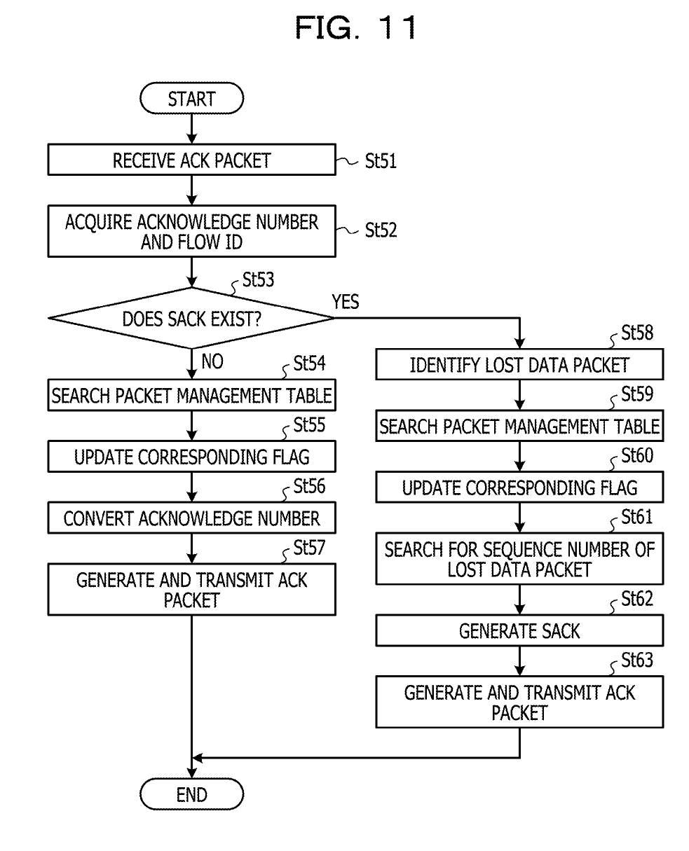

FIG. 11 is a flowchart illustrating an example of processing of the ACK packet received from the server apparatus 2. Reception ports Pr #1, #2 receive the ACK packet from the server apparatus 2 (step St51).

The response processor 124 acquires the acknowledge number from the TCP header of the ACK packet and acquires the flow ID from the IP address and port number (step St52). Next, the response processor 124 determines from the optional area of the ACK packet whether there exists the SACK (step St53).

In a case where there exists no SACK (step St53: No), the response processor 124 searches the packet management table 100b for the sequence number of the ACK packet for the sequence number of the flow #3 (step St54). Next, the response processor 124 updates the corresponding flag to “Fa” (step St55).

Next, referring to the packet management table 100b, the response generator 125 converts the acknowledge number of the ACK packet into a value of the flow #3 (step St56). Next, the response generator 125 generates the ACK packet including the acknowledge number and transmits from the transmission port Ps #3 corresponding to the flow #3 (step St57).

In a case where there exists the SACK (step St53: Yes), the response processor 124 identifies the sequence number of the lost data packet from the left edge of the optional area (step St58). In this operation, the response processor 124 updates the flag of the packet management table 100b to “Fa” for the sequence number of the data packet whose reception may be confirmed from the left edge.

Next, the response processor 124 searches the packet management table 100b for the sequence number of the lost data packet for the sequence number of the flow #1 or #2 (step St59). Next, the response processor 124 updates the corresponding flag of the packet management table 100b to “Fd” (step St60). Next, the response processor 124 searches the packet management table 100b for the sequence number in flows #1, #2 corresponding to the sequence number of the lost data packet (step St61). Thus, the sequence number of the lost data packet in the flow #1 or #2 is converted into the sequence number in flows #3.

Next, the response generator 126 generates a selective acknowledge for notifying the sequence number (step St62). More specifically, the response generator 126 generates a left edge and a right edge illustrated in FIG. 3. Next, the response generator 126 generates the ACK packet (SACK) including the selective acknowledge and transmits from the transmission port Ps #3 to the server apparatus 2 (step St63). Thus, the sequence number of the lost data packet is notified to the client apparatus 3, and thereby the lost data packet is retransmitted from the client apparatus 3.

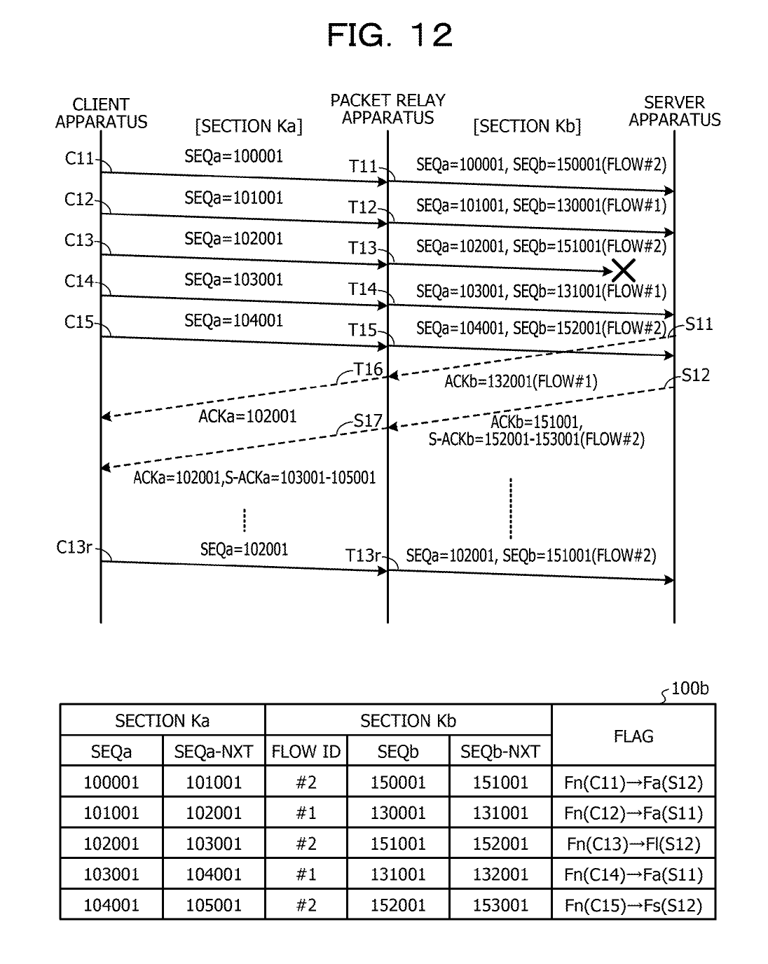

FIG. 12 is a sequence diagram illustrating an example of relay processing of the data packet from the client apparatus 3 to the server apparatus 2. In FIG. 12, flow of the data packet is indicated with solid line arrows, and flow of the ACK packet is indicated with broken line arrows. FIG. 12 also illustrates the content registered in the packet management table 100a in the relay processing. In FIG. 12, description of matters common to FIG. 8 is omitted.

As indicated by reference numerals C11 to C15, the client apparatus 3 transmits data packets of the flow #3 to the packet relay apparatus 1. In this embodiment, length of data packets is 1000 (Byte) by way of example. Data packets of the flow #3 are assigned with sequence numbers in the flow #3 “100001” to “104001”.

Upon receiving the data packet, the packet relay apparatus 1 assigns the flow ID and sequence number to the data packet. The packet relay apparatus 1 registers the sequence number SEQa in the flow #3 assigned to the data packet and the sequence number SEQb and flow ID in flows #1, #2 assigned to the data packet into the packet management table 100a. In this operation, the packet relay apparatus 1 sets “Fn” to the flag of the packet management table 100b.

As indicated by reference numerals T11 to T15, the packet relay apparatus 1 converts data packets of the flow #3 into data packets of the flow #1 or flow #2, and transmits to the server apparatus 2. The data packet of the flow #1 and the data packet of the flow #2 are alternately transmitted. Data packets of the flow #1 are assigned with sequence numbers in the flow #3 “101001”, “103001”, and sequence numbers in the flow #1 “130001”, “131001”. Data packets of the flow #2 are assigned with sequence numbers in the flow #3 “100001”, “102001”, “104001”, and sequence numbers in the flow #2 “150001”, “151001”, “152001”. As indicated by the mark x, the data packet of the sequence number “151001” in the flow #2 is lost in the section Kb.

The server apparatus 2 receives data packets excluding the data packet of the sequence number “151001”. When received the data packet of the sequence number “131001” in the flow #1, the server apparatus 2 transmits the ACK packet (ACK) including selective acknowledge to the packet relay apparatus 1 as indicated by the reference numeral S11. The acknowledge number ACKb of the ACK packet indicates “132001”.

Upon receiving the ACK packet, the packet relay apparatus 1 confirms reception of the data packet of the sequence number “131001” in the flow #1, and sets “Fa” to the corresponding flag in the packet management table 100b. The packet relay apparatus 1 converts the acknowledge number of the ACK packet “132001” to the acknowledge number ACKa “102001” of the flow #3. As indicated by the reference numeral T16, the packet relay apparatus 1 transmits the ACK packet assigned with the acknowledge number ACKa to the client apparatus 3. Upon receiving the ACK packet, the client apparatus 3 confirms reception of the data packet of the sequence number “101001” from the acknowledge number ACKa.

Upon receiving the data packet of the sequence number “152001”, the server apparatus 2 detects loss of the data packet of the sequence number “151001” based on the sequence number. Thus, after receiving the data packet of the sequence number “152001”, the server apparatus 2 transmits the ACK packet (SACK) including selective acknowledge to the packet relay apparatus 1 as indicated by the reference numeral S12. The ACK packet is assigned with ACKb=“151001” and S-ACKa=“152001-153001”.

Upon receiving the ACK packet, the packet relay apparatus 1 determines from the ACKa=“151001” that data packets of the sequence number “150001” in the flow #2 are received, and determines from the S-ACKa=“152001-153001” that data packets of the sequence number “152001” are received. Here, the left edge and right edge of the S-ACKb are “152001” and “153001” respectively. Thus, the packet relay apparatus 1 detects loss of the data packet of the sequence number “151001”.

The packet relay apparatus 1 sets the flag corresponding to the sequence number “151001” to “Fl” and the flag corresponding to the sequence number “150001” to “Fa” in the packet management table 100b. The packet relay apparatus 1 also sets the flag corresponding to the sequence number “152001” to “Fs”.

By searching the packet management table 100b, the packet relay apparatus 1 determines that the sequence number “151001” in the flow #2 corresponds to the sequence number “102001” of the flow #3. As indicated by the reference numeral T17, the packet relay apparatus 1 transmits the ACK packet of the flow #3 to the client apparatus 3. As there is loss of the data packet of the flow #3, the ACK packet of the flow #3 is assigned with ACKa=“102001” and S-ACKa=“103001-105001”.

Upon receiving the ACK packet, the client apparatus 3 confirms reception of data packets of sequence numbers “101001” and “103001” in the flow #3, and detects loss of the data packet of the sequence number “102001” in the flow #3. Thus, for example, upon receiving the ACK packet of the same ACK number three times from the packet relay apparatus 1, the client apparatus 3 retransmits the lost data packet of the sequence number “102001” as indicated by the reference numeral C13r.

Upon receiving the retransmitted data packet, the packet relay apparatus 1 converts the retransmitted data packet into the data packet of the flow #2 and transmits to the client apparatus 3 as indicated by the reference numeral T13r. More specifically, the transmission port Ps #2 and conversion unit 114 of the packet relay apparatus 1 convert the data packet retransmitted from the client apparatus 3 depending on the ACK packet (reference numeral T17) transmitted by the transmission port Ps #3 into the data packet of the flow #2, and transmit. Thus, the packet relay apparatus 1 may relay the retransmitted packet to the server apparatus 2.

Thus, the packet relay apparatus 1 receives, from the server apparatus 2, the ACK packet notifying the sequence number “151001” of the data packet lost in the flow #2, and searches the packet management table 100a for the sequence number in the flow #3 corresponding to the sequence number. The packet relay apparatus 1 transmits the ACK packet notifying the searched sequence number to the client apparatus 3 of transmission source of the data packet of the flow #3.

Thus, the client apparatus 3 may retransmit the lost data packet to the packet relay apparatus 1, and the packet relay apparatus 1 may transmit the retransmitted data packet to the server apparatus 2. Consequently, the buffer for retransmitting the data packet may be removed from the packet relay apparatus 1.

In this embodiment, loss of the data packet occurs in the section Kb. However, the above operation is also performed even when loss of the data packet occurs in the section Ka.

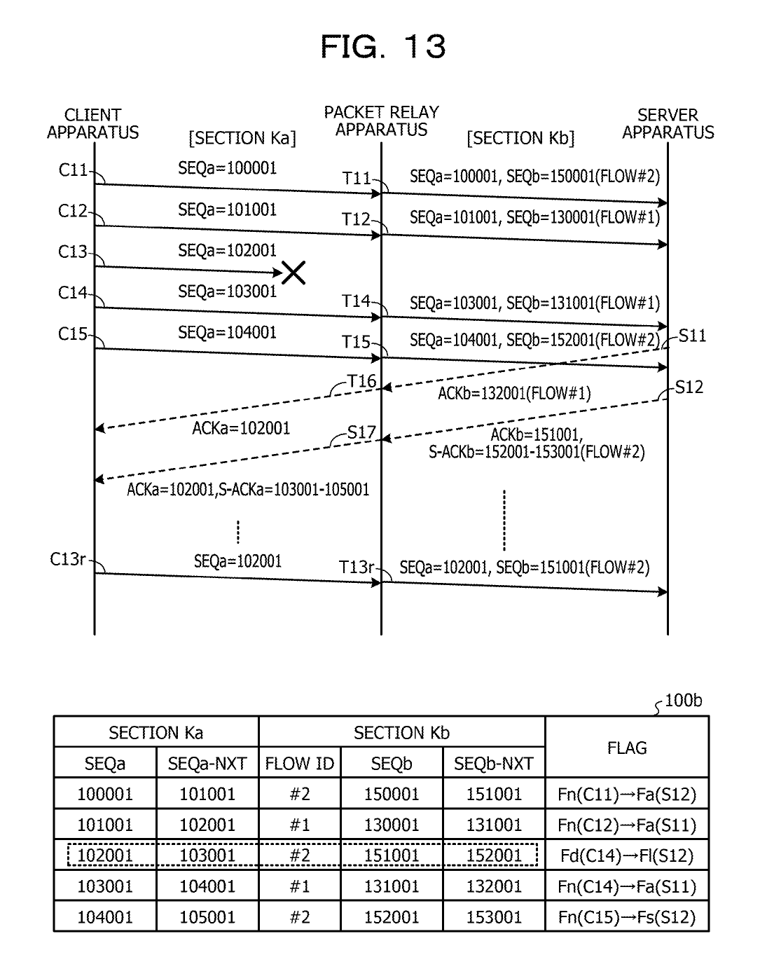

FIG. 13 is a sequence diagram illustrating an example of relay processing of the data packet from the client apparatus 3 to the server apparatus 2. FIG. 13, matters common to FIG. 12 are assigned with same reference numerals, and description thereof is omitted.

In this embodiment, the data packet of the sequence number “102001” in the flow #3 is lost in the section Ka as indicated by the mark x. The packet relay apparatus 1 detects loss of the data packet from lack of the consecutiveness of the sequence number of the data packet received from the client apparatus 3.

More specifically, upon receiving a data packet next to the lost data packet, the packet relay apparatus 1 detects loss of the data packet from lack of a sequence number between the sequence number of the next data packet and a sequence number of the data packet previously received. The packet relay apparatus 1 registers the correspondence relationship between the sequence number in the flow #3 assigned to the lost data packet and the sequence number in the flow #2 assigned to the data packet into the packet management table 100b (see dotted line frame). The packet relay apparatus 1 also sets the corresponding flag to “Fd”.

Thus, the packet relay apparatus 1 also registers the sequence number of the data packet lost before receiving from the client apparatus 3 into the packet management table 100b. Thus, the packet relay apparatus 1 may search the packet management table 100b for the sequence number of the lost data packet in the same manner as the above example, and notify to the client apparatus 3.

As described above, the packet relay apparatus 1 includes reception ports Pr #1 to #3, the assignment processor 112, transmission ports Ps #1 to #3, the memory M, and the response processor 124. The reception ports Pr #3 receives data packets of the flow #3. The assignment processor 112 assigns the sequence number in the flow #1 or the sequence number in the flow #2 to data packets of the flow #3. Transmission ports Ps #1, #2 and conversion unit 114 convert data packets of the flow #3 into data packets of the flow #1 or data packets of the flow #2 in accordance with the assignment of the assignment processor 112 and transmit.

The memory M stores the packet management table 100b. The packet management table 100b registers the correspondence relationship between the sequence number in the flow #3 assigned to data packets of the flow #3 and the sequence number in the flow #1 assigned to data packets thereof or the sequence number in the flow #2.

Reception ports Pr #1, #2 receive the ACK packet notifying the sequence number of the packet lost in the flow #1 or flow #2. The response processor 124 searches the packet management table 100b for a sequence number in the flow #3 corresponding to a sequence number in the flow #1 indicated by the ACK packet or a sequence number in the flow #2. The transmission port Ps #3 transmits the ACK packet notifying loss of the packet of the sequence number searched by the response processor 124 to the client apparatus 3 that is the transmission source of the data packet of the flow #3.

Thus, the packet relay apparatus 1 may notify the sequence number of the lost data packet in the flow #3 to the client apparatus 3. As the client apparatus 3 retransmits the data packet depending on the notification from the packet relay apparatus 1, the buffer for storing the data packet for retransmission may be removed from the packet relay apparatus 1. Consequently, the buffer is removed from the packet relay apparatus 1.

In this embodiment, the packet relay apparatus 1 converts the sequence number of the ACK packet received from the server apparatus 2 and relays to the client apparatus 3. However, it is not limited thereto. The packet relay apparatus 1 may generate the ACK packet before receiving from the ACK packet from the server apparatus 2 and transmit to the client apparatus 3. In this case, the client apparatus 3 may detect the sequence number of the lost data packet at a timing earlier than in the above example.

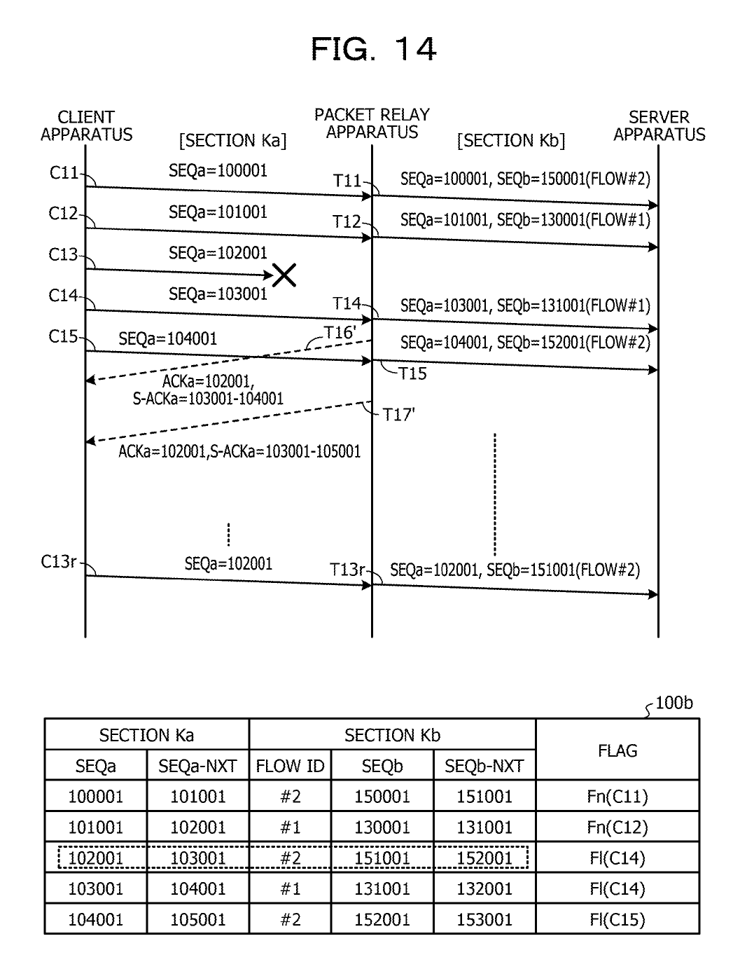

FIG. 14 is a sequence diagram illustrating an example of transmission processing of the ACK packet from the packet relay apparatus 1 to the client apparatus 3. In FIG. 14, matters common to FIG. 13 are assigned with same reference numerals, and description thereof is omitted.

Upon receiving data packets of the sequence number “103001” from the client apparatus 3, the packet relay apparatus 1 generates the ACK packet including selective acknowledge and transmits to the client apparatus 3 as indicated by reference numerals C14, T16′. The ACK packet is assigned with ACKa=“102001” and S-ACKa=“103001-104001”.

Upon receiving data packets of the sequence number “104001” from the client apparatus 3, the packet relay apparatus 1 generates the ACK packet including the selective acknowledge and transmits to the client apparatus 3 as indicated by reference numerals C15, T17′. The ACK packet is assigned with ACKa=“102001” and S-ACKa=“103001-105001”.

Thus, the packet relay apparatus 1 generates the ACK packet before receiving the ACK packet from the server apparatus 2 and transmits to the client apparatus 3. Thus, the client apparatus 3 may receive the ACK timing and detect the sequence number of the lost data packet at a timing earlier than in the example of FIG. 13.

### Other Embodiment

The packet relay apparatus 1 may include a data packet retransmission function in preparation for the congestion of data packets in a network.

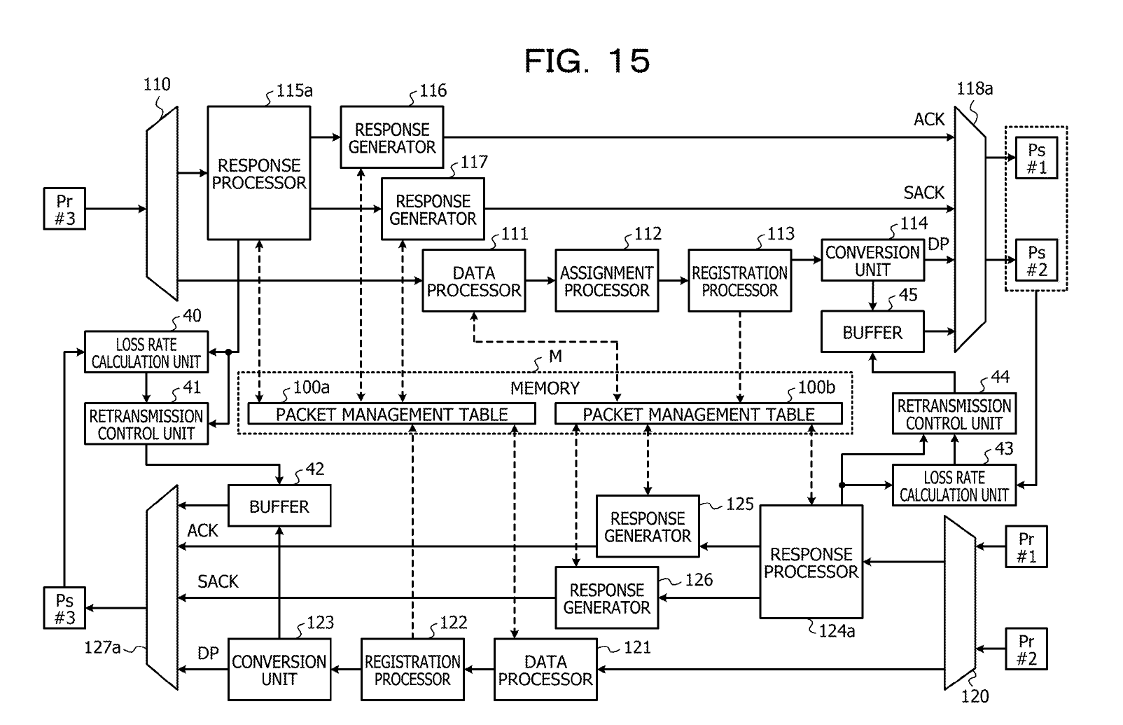

FIG. 15 illustrates a configuration diagram of the packet relay apparatus 1 according to another embodiment. In FIG. 15, configurations common to FIG. 4 are assigned with same reference numerals, and description thereof is omitted.

The packet relay apparatus 1 includes transmission ports Ps#1 to #3, reception ports Pr #1 to #3, separation units 110, 120, multiplexers 118a, 127a, data processors 111, 121, the assignment processor 112, registration processors 113, 122, and conversion units 114, 123. Further, the packet relay apparatus 1 includes response processors 115a, 124a, response generators 116, 117, 125, 126, loss rate calculation units 40, 43, retransmission control units 41, 44, buffers 42, 45 and the memory M.

Multiplexers 118a, 127a, response processors 115a, 124a, loss rate calculation units 40, 43, retransmission control units 41, 44, and buffers 42, 45 are configured by, for example, software functions driving the CPU, or the FPGA or the ASIC.

The loss rate calculation unit 43 calculates the data packet loss frequency based on the ACK packet received by reception ports Pr #1, #2. The loss rate calculation unit 43 detects transmission of data packets from transmission ports Ps #1, #2 and detects loss of the data packet from the response processor 124a. In addition to the above function of the response processor 124, the response processor 124a includes a function of detecting loss of the data packet from the acknowledge number and selective acknowledge number of the ACK packet. The loss rate calculation unit 43 calculates the ratio of the loss frequency ratio with respect to the transmission frequency of the data packet as the loss rate at regular intervals.

The retransmission control unit 44 controls operation state of the uplink relay processing to a retransmission mode or a non-retransmission mode based on the loss rate of the data packet calculated by the loss rate calculation unit 43. When the loss rate of the data packet of the flow #1 or flow #2 is a predetermined threshold value TH or higher, the retransmission control unit 44 switches the operation state to the retransmission mode, and when the loss rate of the data packet of the flow #1 or flow #2 is lower than a predetermined threshold value TH, the retransmission control unit 44 switches the operation state of the corresponding flow to the non-retransmission mode. The buffer 45 acquires converted data packets from the conversion unit 114 and stores in retransmission mode, but does not store data packets in the non-retransmission mode.

The retransmission control unit 44 performs retransmission control of the lost data packet in the uplink relay processing. The retransmission control unit 44 outputs the lost data packet stored in the buffer 45 to the multiplexer 118a in accordance with the instruction of the response processor 124a. The multiplexer 118a time-division multiplexes the ACK packet from the response generators 116, 117 and the data packet from the conversion unit 114 and buffer 45 and transmits from the corresponding transmission port Ps #1 or #2.

The loss rate calculation unit 40 calculates loss frequency of the data packet based on the ACK packet received by the reception port Pr #3. The loss rate calculation unit 40 detects transmission of the data packet from the transmission port Ps #3 and detects loss of the data packet from the response processor 115a. In addition to the above function of the response processor 115, the response processor 115a includes a function of detecting loss of the data packet from the ACK packet including the selective acknowledge. The loss rate calculation unit 40 calculates the ratio of the loss frequency with respect to the transmission frequency of the data packet as the loss rate at regular intervals. The loss rate is an example of the loss frequency.

The retransmission control unit 41 controls operation state of the downlink relay processing into the retransmission mode or the non-retransmission mode based on the loss rate of the data packet calculated by the loss rate calculation unit 40. When the loss rate of the data packet is a predetermined threshold value TH or higher, the retransmission control unit 41 switches the operation state to the retransmission mode, and when the loss rate of the data packet is lower than a predetermined threshold value TH, the retransmission control unit 41 switches the operation state to the non-retransmission mode. The buffer 42 acquires converted data packets from the conversion unit 123 and stores in retransmission mode, but does not store the data packets in the non-retransmission mode. The buffer 42 functions as an accumulator accumulating data packets of the flow #3.

The retransmission control unit 41 performs retransmission control of the lost data packet in the downlink relay processing. The retransmission control unit 41 outputs the lost data packet stored in the buffer 42 to the multiplexer 127a in accordance with the instruction of the response processor 115a. The multiplexer 127a time-division multiplexes the ACK packet from response generators 125, 126 and data packets from the conversion unit 123 and buffer 42 and transmits from the transmission port Ps #3.

Thus, in a case where the loss rate is the threshold value TH or higher, the retransmission control unit 41 accumulates data packets of the flow #3 transmitted by the transmission port Ps #3 into the buffer 42. The retransmission control unit 41 controls such that packets of the flow #3 accumulated in the buffer 42 are retransmitted from the transmission port Ps #3 according to the ACK packet received by the reception port Pr #3.

Next, retransmission processing in the downlink relay processing is described. Retransmission processing in the uplink relay processing is performed in the same manner as the downlink.

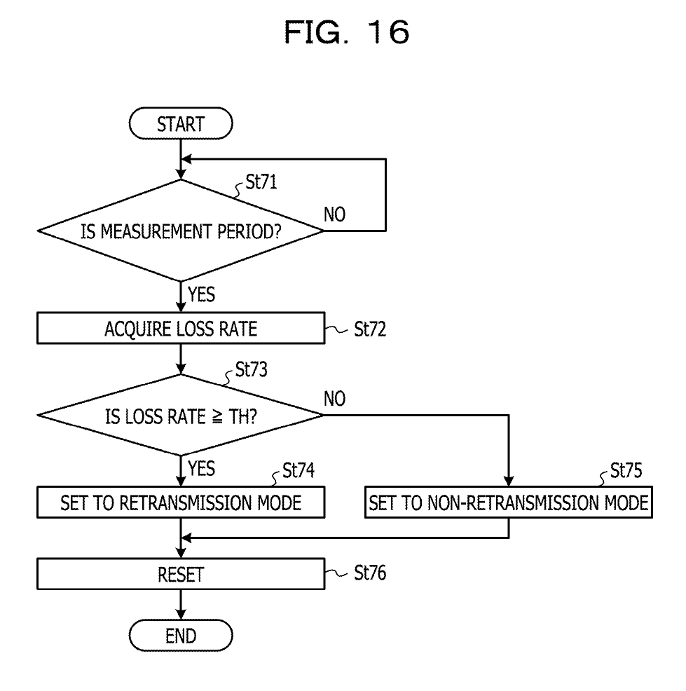

FIG. 16 is a flowchart illustrating an example of the operation switching processing. The retransmission control unit 41 determines, for example, by a timer whether the measurement period comes (step St71). In a case where the measurement period does not come (step St71: No), the retransmission control unit 41 performs the processing of step St71 again.

In a case where the measurement period comes (step St71: Yes), the retransmission control unit 41 acquires the loss rate of the data packet from the loss rate calculation unit 40 (step St72). The retransmission control unit 41 compares the loss rate with a predetermined threshold value TH (step St73). In a case where the loss rate is the threshold value TH or higher (step St73: Yes), the retransmission control unit 44 sets operation state to the retransmission mode (step St74), and in a case where the loss rate is lower than the threshold value TH (step St73: No), the retransmission control unit 44 sets the operation state to the non-retransmission mode (step St75).

Next, the retransmission control unit 41 resets the transmission frequency and loss frequency of data packets counted by the loss rate calculation unit 40 to 0 (step St76). Thus, operation switching processing is performed.

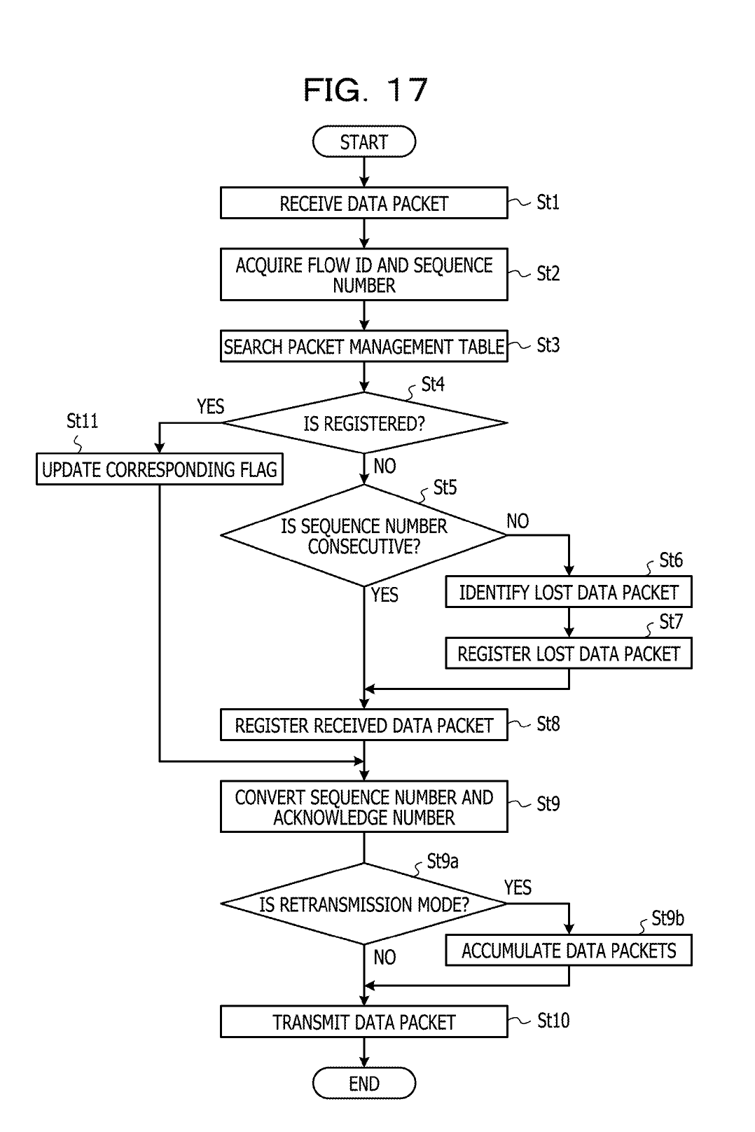

FIG. 17 is a flowchart illustrating another example of processing of the data packet received from the server apparatus 2. In FIG. 17, processing common to FIG. 6 are assigned with same reference numerals, and description thereof is omitted.

After conversion by the conversion unit 123 (step St9), when the operation state is the retransmission mode (step St9a: Yes), the buffer 42 accumulates data packets outputted from the conversion unit 123 (step St9b). When the operation state is the non-retransmission mode (step St9a: No), the buffer 42 does not accumulate the data packets. Thereafter, the transmission port Ps #3 transmits the data packet (step St10). Thus, processing of the data packet received from the server apparatus 2 are performed.

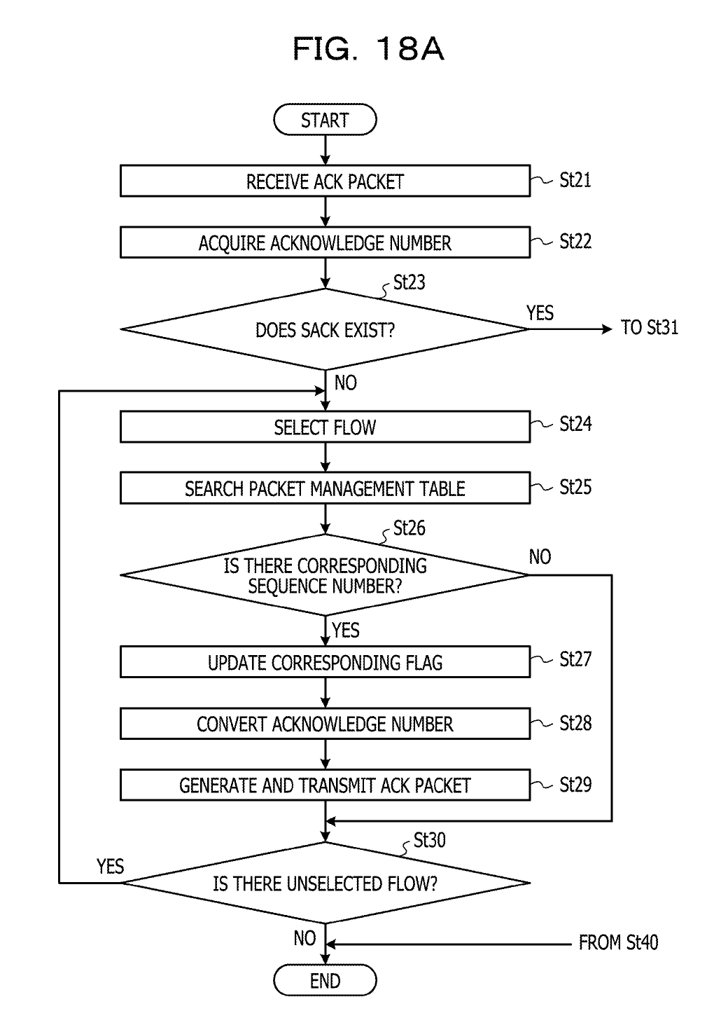

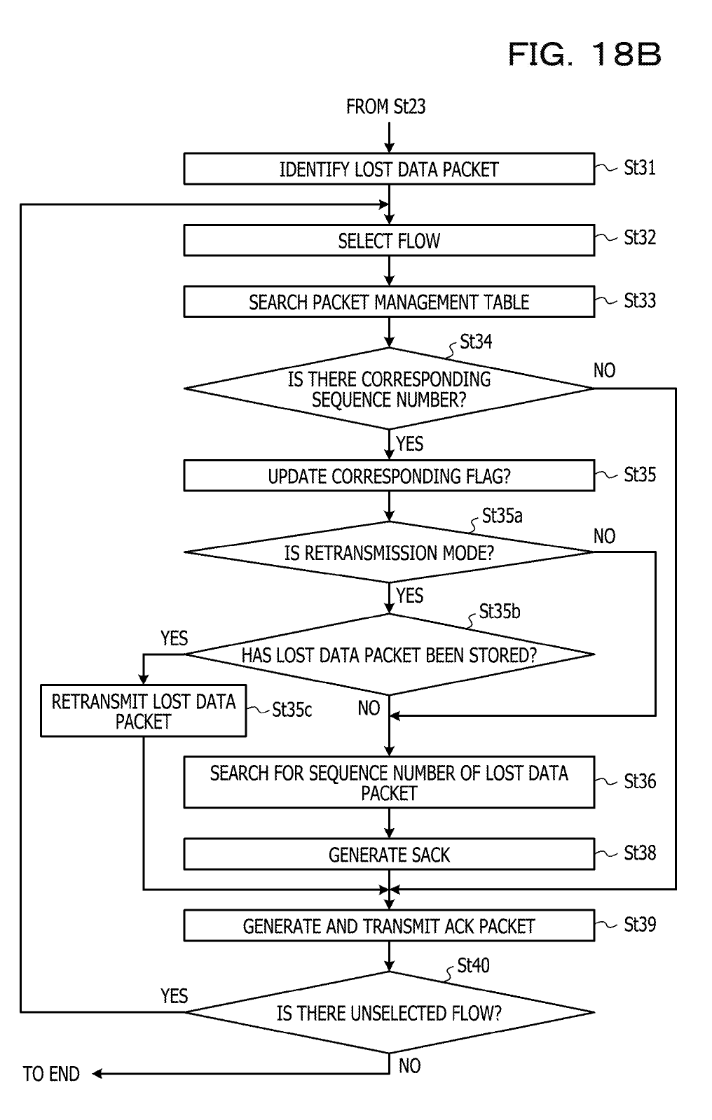

FIGS. 18A and 18B are flowcharts illustrating an example of processing of the ACK packet received from the client apparatus 3. In FIGS. 18A and 18B, processing common to FIGS. 7A and 7B are assigned with same reference numerals, and description thereof is omitted.

After flag updating processing (step St35), the retransmission control unit 41 determines whether the operation state is the retransmission mode (step St35a). In a case where the operation state is the non-retransmission mode (step St35a: No), processing of steps St36 to St40 are performed. In a case where the operation state is the retransmission mode (step St35a: Yes), the retransmission control unit 41 determines based on the sequence number whether the lost data packet has been stored into the buffer 42 (step St35b). In a case where the lost data packet is not stored (step St35b: No), processing of steps St36 to St40 are performed.

In a case where the lost data packet has been stored (step St35b: Yes), the retransmission control unit 41 retransmits the lost data packet in the buffer 42 from the transmission port Ps #3 (step St35c). Next, the response generator 116 generates and transmits the ACK packet of acknowledge (step St39). Thereafter, the processing of step St40 is performed. Thus, processing of the ACK packet received from the client apparatus 3 is performed.

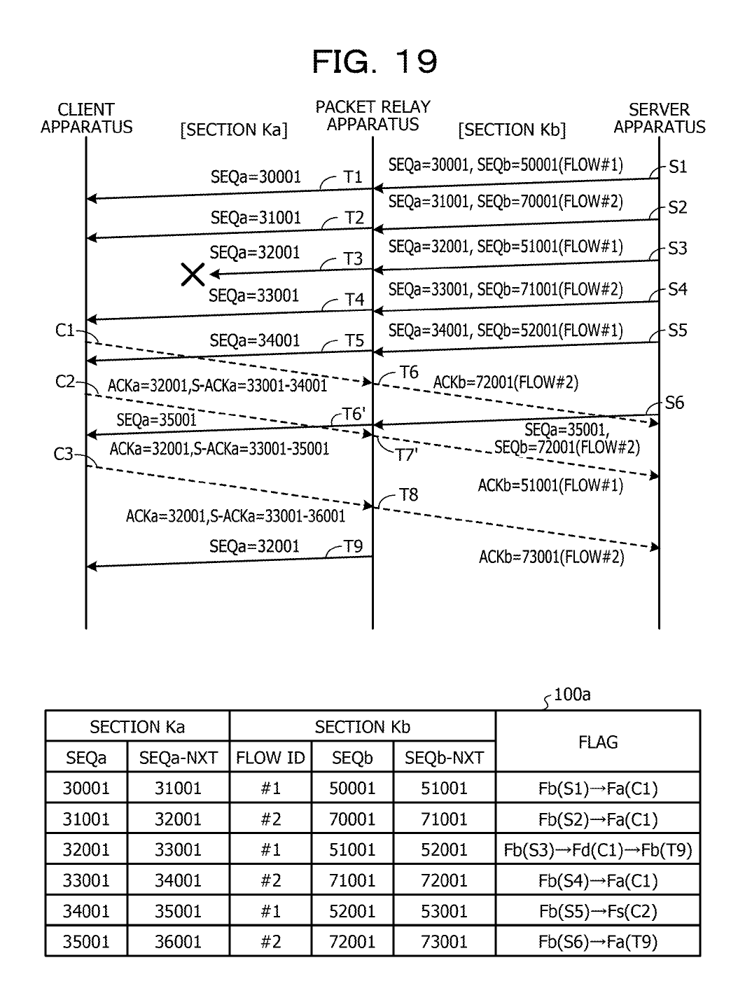

FIG. 19 is a sequence diagram illustrating another example of relay processing of the data packet from the server apparatus 2 to the client apparatus 3. In FIG. 19, matters common to FIG. 8 are assigned with same reference numerals, and description thereof is omitted.

As indicated by reference numerals S1 to S6, the server apparatus 2 alternately transmits data packets of flows #1, #2 to the packet relay apparatus 1. In this embodiment, length of data packets is 1000 (Byte) by way of example. The data packet of the flow #2 indicated by the reference numeral S6 is assigned with sequence number “72001” in the flow #2, and the sequence number “35001” in the flow #3.

Upon receiving the data packet, the packet relay apparatus 1 registers the sequence number SEQa in the flow #3 assigned to the data packet and the sequence number SEQb and flow ID in flows #1, #2 into the packet management table 100a. In this operation, the packet relay apparatus 1 sets “Fb” to the flag of the packet management table 100a. The flag “Fb” indicates that the data packet has been stored into the buffer 42.

As indicated by reference numerals T1 to T5 and T6′, the packet relay apparatus 1 converts data packets in flows #1, #2 into data packets of the flow #3, and transmits to the client apparatus 3. The packet relay apparatus 1 converts data packets in flows #2 indicated by the reference numeral S6 into data packets of the sequence number “35001”, and transmits to the client apparatus 3.

Upon receiving the ACK packet indicated by the reference numeral C2 from the client apparatus 3, the packet relay apparatus 1 transmits the ACK packets of the flow #1 assigned with the acknowledge number ACKb=“51001” to the server apparatus 2 (reference numeral T7′) unlike the above example. Since the ACK packet is acknowledge, the server apparatus 2 confirms reception of data packets of the sequence number “50001” in the flow #1 and does not retransmit the data packets. Like the above example, the packet relay apparatus 1 may transmit the ACK packet including the line tack acknowledge to the server apparatus 2.

Upon receiving the data packet of the sequence number “34001”, the client apparatus 3 transmits the ACK packet assigned with ACKa=“32001” and selective acknowledge S-ACKa=“33001-36001” to the packet relay apparatus 1 as indicated by the reference numeral C3. Upon receiving the ACK packet, the packet relay apparatus 1 transmits the ACK packet of the flow #2 assigned with the acknowledge number ACKb=“73001” to the server apparatus 2 as indicated by the reference numeral T8.

Next, the packet relay apparatus 1 retransmits the data packet assigned with the sequence number “32001” of the lost data packet to the client apparatus 3 as indicated by the reference numeral T9. In this operation, the packet relay apparatus 1 updates the flag corresponding to the sequence number “32001” (SEQa) to “Fb” and the flag corresponding to the sequence number “35001” (SEQa) to “Fa”.

Thus, the packet relay apparatus 1 performs retransmission processing of the data packet when the loss rate of the data packet is the threshold value TH or higher. Therefore, for example, communication quality in a congested network may be improved.

In the above embodiment, the packet relay apparatus 1 relays the TCP packet between the TCP section Ka and MPTCP section Lb. However, it is not limited thereto. When the packet relay apparatus 1 is coupled with the client apparatus 3 by, for example, a link aggregation configured by a plurality of communication lines in the section Ka, the TCP packet may be relayed between MPTCP sections Ka and Kb.

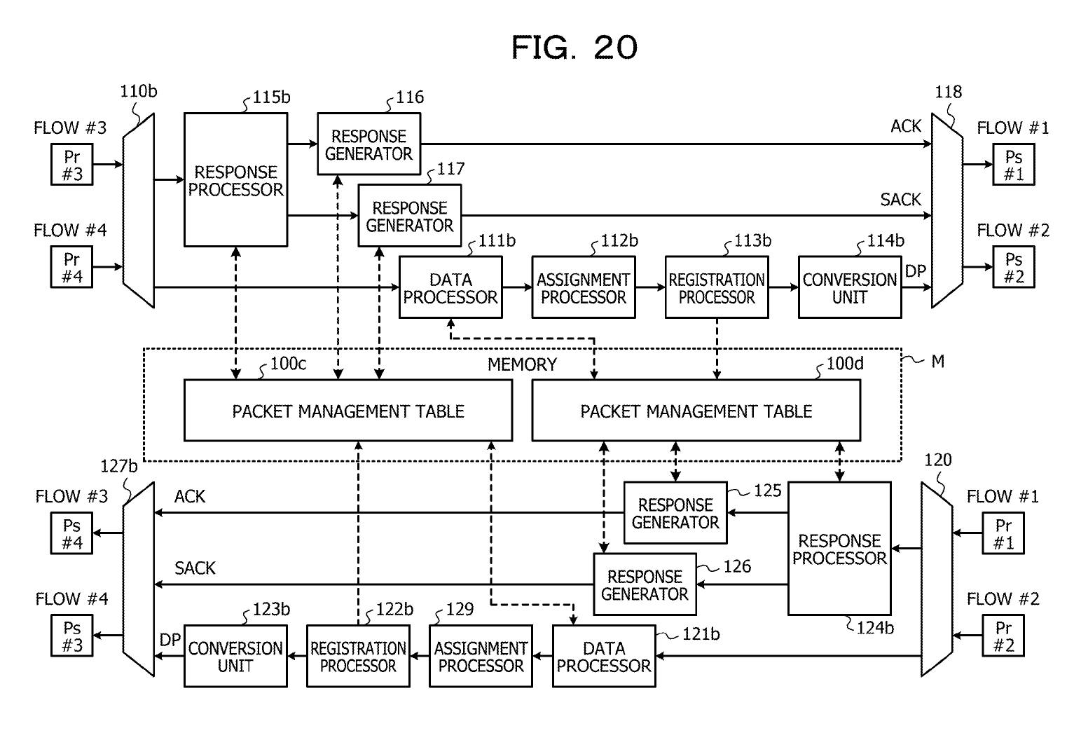

FIG. 20 illustrates a configuration diagram of a packet relay apparatus 1 according to another embodiment. In FIG. 20, configurations common to FIG. 4 are assigned with same reference numerals, and description thereof is omitted.

The packet relay apparatus 1 includes transmission ports Ps #1 to #4, reception ports Pr #1 to #4, separation units 110b, 120, multiplexers 118, 127b, data processors 111b, 121b, assignment processors 112b, 129, registration processors 113b, 122b, and conversion units 114b, 123b. Further, the packet relay apparatus 1 includes response processors 115b, 124b, response generators 116, 117, 125, 126, and the memory M.

Components 110b to 115b, 116 to 118, 120, 121b to 124b, 125, 126, 127b, and 129 are configured by, for example, software functions driving the CPU, or the FPGA or the ASIC.

In this embodiment, the packet relay apparatus 1 receives data packets of flows #1, #2 from the server apparatus 2, converts the received data packets of the flows #1, #2 into data packets of the flow #3 or flow #4, and transmits to the client apparatus 3. The packet relay apparatus 1 receives data packets of flows #3, #4 from the client apparatus 3, converts the received data packets of the flows #3, #4 into data packets of the flow #1 or flow #2, and transmits to the server apparatus 2.

The memory M stores packet management tables 100c, 100d. One packet management table 100c registers the correspondence relationship between the flow ID and sequence number of the data packet relayed in the downward direction, and another packet management table 100b registers the correspondence relationship between the flow ID and sequence number of the data packet relayed in the upward direction.

More specifically, in the packet management tables 100c, 100d, the correspondence relationship between the flow ID (#1, #2), sequence number in flows #1, #2 and the flow ID (#3, #4), sequence number in flows #3, #4. The memory M is an example of a storage unit that stores packet management tables 100c, 100d. A hard disk drive may be used as the storage unit.

Reception ports Pr #1 to #4 include, for example, a demodulator and a photodiode, and receive the TCP packet. Transmission ports Ps #1 to #4 include, for example, a modulator and a laser diode, and transmit the TCP packet.

Reception ports Pr #3, #4 receive the TCP packet of flows #3, #4 from the client apparatus 3 respectively, and output to the separation unit 110b. The separation unit 110b outputs the data packet among the TCP packet received from reception ports Pr #3, #4 to the data processor 111b, and outputs the ACK packet to the response processor 115b.

The data processor 111b performs various processing for the data packet. The data processor 111b acquires the flow ID and sequence number of the data packet. The data processor 111b determines from the search result whether the flow ID and sequence number of the data packet are registered, and depending on the determination result, instructs the assignment processor 112b to assign the flow ID and sequence number.

In a case where the sequence number is not registered as the search result, the data processor 111b determines based on, for example, the sequence number SEQa-NXT of the packet management table 100d, whether the data packet is lost. Namely, the data processor 111b detects loss of the data packet from lack of the consecutiveness of the sequence number in flow #3, #4 of the data packet. In a case where the data packet is lost, the data processor 111b instructs the assignment processor 112b to assign the sequence number of the lost data packet.

The assignment processor 112b assigns the flow ID and sequence number to the received data packet in accordance with the instruction of the data processor 111b. The assignment processor 112 also assigns the flow ID and sequence number to the lost data packet in accordance with the instruction of the data processor 111b.

More specifically, the assignment processor 112b assigns the flow ID (#1 or #2) and sequence number to data packets of flows #3, #4. Thus, data packets of flows #3, #4 are assigned to data packets of the flow #1 and data packets of the flow #2. The method of allocating data packets is not limited.

In accordance with the instruction of the assignment processor 112b, the registration processor 113b registers the correspondence relationship between the flow ID (#3, #4) of data packets of flows #3, #4 and the flow ID (#1, #2) and sequence number assigned to data packets thereof into the packet management table 100d. The registration processor 113b outputs the data packet processed thereby to the conversion unit 114b.

The conversion unit 114b converts data packets of flows #3, #4 into data packets of flows #1, #2. More specifically, the conversion unit 114 replaces the sequence number of data packets with a sequence number assigned to data packets and replaces the acknowledge number according to the assigned sequence number. Thus, the sequence number and acknowledge number of flows #3, #4 are converted to the sequence number and acknowledge number of flows #1, #2 in the data packets. The conversion unit 114b outputs the data packets (DP) of flows #1, #2 to the multiplexer 118.

The response processor 115b performs various processing for the ACK packets received from the separation unit 110b. The ACK packet is an acknowledge corresponding to the downlink data packet. The response processor 115b acquires the acknowledge number from the ACK packet and controls the flag of the packet management table 100c for each of flows #1, #2 based on the acknowledge number.

The response processor 115b also determines from the optional area of the ACK packet whether there exists the SACK. In a case where the SACK exists, the response processor 115b identifies the flow ID of the lost data packet and sequence number in flows #3, #4 from the left edge (see FIG. 3), and searches the packet management table 100c for a sequence number in flows #1, #2 corresponding to the sequence number.

The response processor 115b notifies the searched flow ID and sequence number in flows #1, #2 to the response generator 117 and instructs to generate the ACK packet (SACK) including the SACK based on the sequence number. In a case where the SACK does not exist, the response processor 115b converts the acknowledge number into an acknowledge number of flows #1, #2 based on the packet management table 100c, and notifies and instruct the response generator 116 to generate the ACK packet (ACK) of the acknowledge based on the sequence number.

Thus, the response processor 115b searches the packet management table 100c for a sequence number in the flow #1 or flow #2 corresponding to the sequence number in flows #3, #4 indicated by the ACK packet of acknowledge.

The separation unit 120 outputs the data packet among the TCP packet received from reception ports Pr #1, #2 to the data processor 121b, and outputs the ACK packet to the response processor 124b.

The data processor 121b performs various processing for the data packet. The data processor 121b acquires the flow ID and sequence number of the data packet. The data processor 121b determines from the search result whether the flow ID and sequence number of the data packet are registered, and depending on the determination result, instructs the assignment processor 129 to assign the flow ID and sequence number.

In a case where the sequence number is not registered as the search result, the data processor 121b determines based on, for example, the sequence number SEQa-NXT of the packet management table 100c, whether the data packet is lost. Namely, the data processor 121b detects loss of the data packet from lack of the consecutiveness of the sequence number in flows #1, #2 of the data packet. In a case where the data packet is lost, the data processor 121b instructs the assignment processor 129 to assign the sequence number of the lost data packet.

The assignment processor 129 assigns the flow ID and sequence number to the received data packet in accordance with the instruction of the data processor 121b. The assignment processor 129 also assigns the flow ID and sequence number to the lost data packet in accordance with the instruction of the data processor 121b.

More specifically, the assignment processor 112b assigns the flow ID (#3 or #4) and sequence number to data packets of flows #1, #2. Thus, data packets of flows #1, #2 are assigned to data packets of the flow #3 and data packets of the flow #4. The method of allocating the data packet is not limited.

In accordance with the instruction of the assignment processor 129, the registration processor 122b registers the correspondence relationship between the flow ID (#1, #2) and sequence number of the data packet of flows #1, #2 and the flow ID (#3, #4) and sequence number assigned to the data packet into the packet management table 100c. The registration processor 122b outputs the data packet processed thereby to the conversion unit 123b.

The conversion unit 123b converts data packets of flows #1, #2 into data packets of flows #3, #4. More specifically, the conversion unit 123b replaces the sequence number of the data packet with a sequence number assigned to the data packet and replaces the acknowledge number according to the assigned sequence number. Thus, the sequence number and acknowledge number of flows #1, #2 are converted to the sequence number and acknowledge number of flows #3, #4 in the data packet. The conversion unit 123b outputs data packets (DP) of flows #3, #4 to the multiplexer 127b.

The multiplexer 127b time-division outputs the ACK packet (ACK) of acknowledge received from the response generator 125, the ACK packet (SACK) including the selective acknowledge received from the response generator 126, and the data packet (DP) received from the conversion unit 123b to the transmission port Ps #3 or #4 depending on flows #3, #4 thereof respectively.

The response processor 124b performs various processing for the ACK packets received from the separation unit 120. The ACK packet is an acknowledge corresponding to the uplink data packet. The response processor 124b acquires the acknowledge number from the ACK packet and controls the flag of the packet management table 100d for each of flows #1, #2 based on the acknowledge number.

The response processor 124b also determines from the optional area of the ACK packet whether there exists the SACK. In a case where the SACK exists, the response processor 124b identifies the flow ID of the lost data packet and sequence number in flows #1, #2 from the left edge (see FIG. 3), and searches the packet management table 100d for a sequence number in flows #3, #4 corresponding to the sequence number.

The response processor 124b notifies the searched flow ID and sequence number in flows #3, #4 to the response generator 126 and instructs to generate the ACK packet (SACK) including the selective acknowledge based on the sequence number. In a case where the SACK does not exist, the response processor 124b converts the acknowledge number into an acknowledge number of flows #3, #4 based on the packet management table 100d, and notifies and instruct the response generator 125 to generate the ACK packet (ACK) of the acknowledge based on the sequence number.

Thus, the response processor 124b searches the packet management table 100d for a sequence number in flows #1, #2 indicated by the ACK packet and a sequence number in the flow #3 corresponding to the SACK or a sequence number in the flow #4.

Next, downlink relay processing of the packet relay apparatus 1 according to this embodiment is described. In the uplink relay processing, the correspondence relationship between flow IDs is reversed. However, since the same processing is performed, description thereof is omitted.

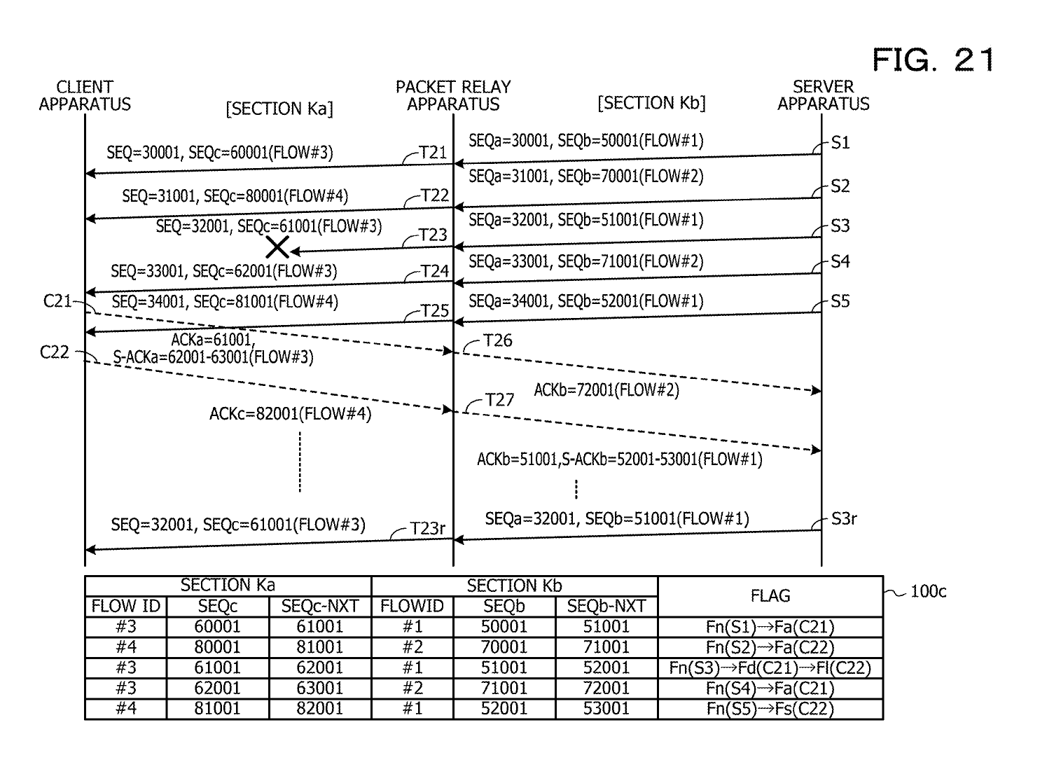

FIG. 21 is a sequence diagram illustrating another example of relay processing of the data packet from the server apparatus 2 to the client apparatus 3. In FIG. 21, matters common to FIG. 8 are assigned with same reference numerals, and description thereof is omitted. The SEQ indicates a sequence number in a flow of a single communication line in a section other than sections Ka, Kb, the SEQc indicates a sequence number in flows #3, #4 in the section Ka, and the SEQb indicates a sequence number in flows #1, #2 in the section Kb.

The packet management table 100c registers the flow ID, the sequence number SEQc, and the sequence number SEQc-NXT next to the sequence number SEQc in the section Ka, and the flow ID, the sequence number SEQb, and the sequence number SEQb-NEXT next to the sequence number SEQb by associating with each other. The packet management table 100c also registers the flag for each of sequence numbers SEQb, SEQc.

As indicated by reference numerals S1 to S5, the server apparatus 2 alternately transmits data packets of flows #1, #2 to the packet relay apparatus 1. In this embodiment, length of data packets is 1000 (byte) by way of example. Data packets of the flow #1 are assigned with the sequence number SEQ and the sequence number SEQb in the flow #1, and data packets of the flow #2 are assigned with the sequence number SEQ and the sequence number SEQb in the flow #2.

Upon receiving the data packet of the flow #1 or flow #2 indicated by reference numerals S1 to S5, the packet relay apparatus 1 registers the flow ID (#1, #2) thereof and the sequence number SEQb in flows #1, #2 into the packet management table 100c. The packet relay apparatus 1 assigns the flow ID (#3, #4) and the sequence number SEQc in flows #3, #4 to the received data packet and registers into the packet management table 100c. In this operation, the packet relay apparatus 1 sets “Fn” to the flag of the packet management table 100c.

As indicated by reference numerals T21 to T25, the packet relay apparatus 1 converts data packets into data packets of the flow #3 or flow #4, and transmits to the client apparatus 3. The data packet of the flow #3 is assigned with sequence numbers in the flow #3 “60001”, “61001”, “62001”. Data packets of the flow #4 are assigned with sequence numbers in the flow #4 “80001”, “81001”. As indicated by the mark x, the data packet of the sequence number “61001” is lost in the section Ka.

The client apparatus 3 receives data packets excluding the data packet of the sequence number “61001”. Upon receiving the data packet of the sequence number “62001”, the client apparatus 3 detects loss of the data packet of the sequence number “61001” based on the sequence number. Thus, after receiving the data packet of the sequence number “62001”, the client apparatus 3 transmits the ACK packet (SACK) including selective acknowledge to the packet relay apparatus 1 as indicated by the reference numeral C21. The ACK packet is assigned with ACKa=“61001” and S-ACKa=“62001-63001”.

Upon receiving the ACK packet, the packet relay apparatus 1 determines that the data packet of the sequence number “60001” has been received from the ACKa=“61001”, and determines that the data packet of the sequence number “62001” has been received from the S-ACKa=“62001-63001”. Here, the left edge and right edge of the S-ACKa are “62001” and “63001” respectively. Thus, the packet relay apparatus 1 detects loss of the data packet of the sequence number “61001”.

The packet relay apparatus 1 sets the flag corresponding to the sequence number “61001” to “Fd” and the flag corresponding to sequence numbers “60001”, “62001” to “Fa” in the packet management table 100c.

By searching the packet management table 100c, the packet relay apparatus 1 determines that the sequence number “62001” in the flow #3 corresponds to the sequence number “71001” of the flow #1. As indicated with the reference numeral T26, the packet relay apparatus 1 transmits the ACK packet of the flow #1 to the server apparatus 2. As there is no loss of the data packet of the flow #2, the ACK packet of the flow #2 is acknowledge (ACK) that includes ACKb=“72001”. Upon receiving the ACK packet, the server apparatus 2 confirms reception of the data packet of the sequence number “71001” in the flow #2.

After receiving data packets of the sequence number “81001”, the client apparatus 3 transmits the ACK packet for acknowledge of the data packets to the packet relay apparatus 1 as indicated by the reference numeral C22. The ACK packet is assigned with the acknowledge number ACKc=“82001”.

Upon receiving the ACK packet, the packet relay apparatus 1 determines that data packets of the sequence number “81001” have been received from the ACKc=“82001”. The packet relay apparatus 1 sets the flag corresponding to the sequence number “61001” to “Fl” and the flag corresponding to the sequence number “81001” to “Fs” in the packet management table 100c. The packet relay apparatus 1 also sets the flag corresponding to the sequence number “80001” to “Fa”.

By searching the packet management table 100c, the packet relay apparatus 1 determines that the sequence number “81001” in the flow #4 corresponds to the sequence number “52001” in the flow #1. As indicated with the reference numeral T27, the packet relay apparatus 1 transmits the ACK packet of the flow #1 to the server apparatus 2. As there is loss of the data packet of the flow #1, the ACK packet of the flow #1 includes selective acknowledge and is assigned with ACKb=“51001” and S-ACKb=“52001-53001”.

Upon receiving the ACK packet, the server apparatus 2 confirms reception of data packets of sequence numbers “50001” and “52001” in the flow #1, and detects loss of the data packet of the sequence number “51001” in the flow #1. Thus, for example, upon receiving the ACK packet of the same ACK number three times from the packet relay apparatus 1, the server apparatus 2 retransmits the lost data packet of the sequence number “51001” as indicated by the reference numeral S3r.

Upon receiving the retransmitted data packet, the packet relay apparatus 1 converts the retransmitted data packet into the data packet of the flow #3 and transmits to the client apparatus 3 as indicated by the reference numeral T23r. More specifically, the transmission port Ps #3 and conversion unit 123 of the packet relay apparatus 1 converts the data packet retransmitted from the server apparatus 2 depending on the ACK packet (reference numeral T27) transmitted by the transmission port Ps #1 into the data packet of the flow #3, and transmits. Thus, the packet relay apparatus 1 may relay the retransmitted packet to the client apparatus 3.

Thus, the packet relay apparatus 1 receives the ACK packet notifying the sequence number “61001” of the data packet lost in the flow #3 from the client apparatus 3, and searches the packet management table 100c for a sequence number in the flow #1 corresponding to the sequence number “61001”. The packet relay apparatus 1 transmits the ACK packet notifying the searched sequence number to the server apparatus 2 of transmission source of the data packet of the flow #1.

In this embodiment, loss of the data packet occurs in the section Ka. However, the above operation is performed in the same manner even when loss of the data packet occurs in the section Kb.

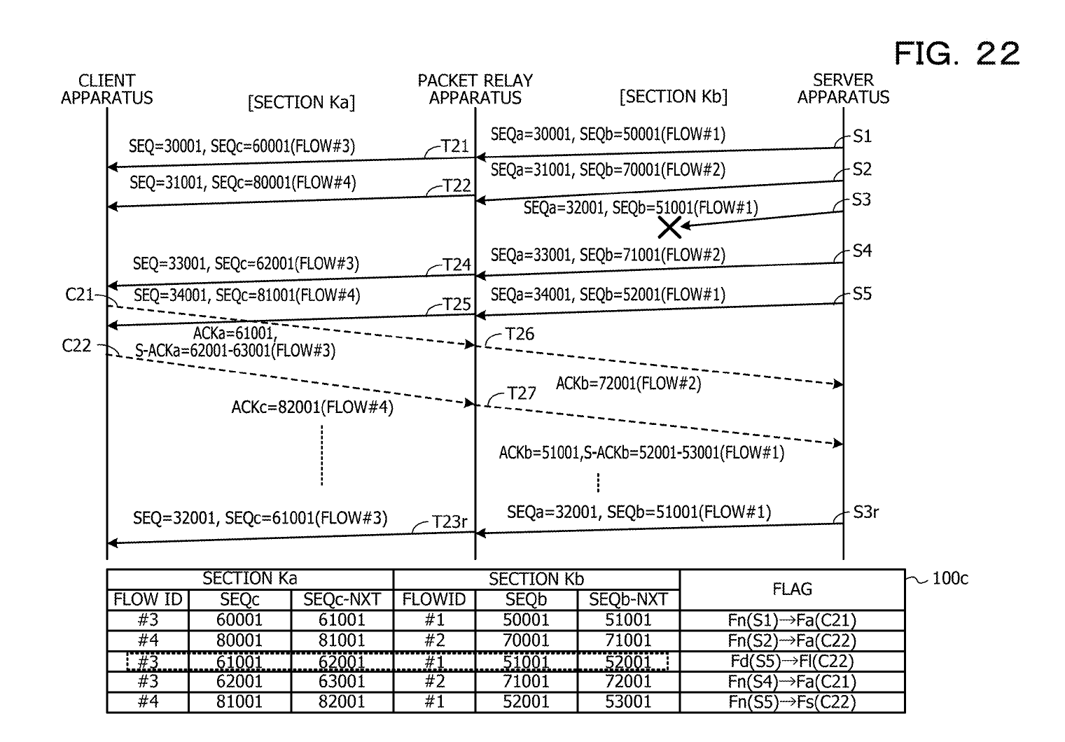

FIG. 22 is a sequence diagram illustrating another example of relay processing of the data packet from the server apparatus 2 to the client apparatus 3. In FIG. 22, matters common to FIG. 21 are assigned with same reference numerals, and description thereof is omitted.

In this embodiment, the data packet of the sequence number “51001” in the flow #1 is lost in the section Kb as indicated by the mark x. The packet relay apparatus 1 detects loss of the data packet from lack of the consecutiveness of the sequence number of the data packet received from the server apparatus 2.

More specifically, upon receiving a data packet next to the lost data packet, the packet relay apparatus 1 detects loss of the data packet from lack of a sequence number between a sequence number of the next data packet and a sequence number of the data packet previously received. The packet relay apparatus 1 registers the correspondence relationship between the sequence number in the flow #1 assigned to the lost data packet and the sequence number in the flow #3 assigned to the data packet thereof into the packet management table 100c (see dotted line frame). The packet relay apparatus 1 also sets the corresponding flag to “Fd”.

Thus, the packet relay apparatus 1 also registers the sequence number of the data packet lost before receiving from the server apparatus 2 into the packet management table 100c. Thus, the packet relay apparatus 1 may search the packet management table 100c for the sequence number of the lost data packet in the same manner as the above example, and notify to the server apparatus 2. In this embodiment, the data packet of the flow #1 is lost. However, the same operation as the above is also performed even when the data packet of the flow #2 is lost.

The above embodiments are preferred embodiments of the present disclosure. However, it is not limited thereto, but various modifications are available within a scope not deviating from the subject matter of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay apparatus configured to relay communication between a first communication apparatus and a second communication apparatus, the relay apparatus comprising:
a memory; and
a processor coupled to the memory and configured to
receive, from the first communication apparatus, a first plurality of packets included in a first flow and a second plurality of packets included in a second flow,
transmit, as a third flow, a third plurality of packets including the first plurality of packets and the second plurality of packets to the second communication apparatus,
store, in the memory, a first correspondence relationship between a first sequence number in the first flow assigned to each of the first plurality of packets and a third sequence number in the third flow assigned to each of the third plurality of packets, and a second correspondence relationship between a second sequence number in the second flow assigned to each of the second plurality of packets and the third sequence number,
receive, from the second communication apparatus, a first notification which requests to transmit a first packet included in the third plurality of packets, the first notification indicating the third sequence number assigned to the first packet,
determine which of the first flow and the second flow includes the first packet based on at least one of the first correspondence relationship and the second correspondence relationship, and
transmit a second notification to the first communication apparatus, the second notification indicating the first sequence number assigned to the first packet when the first packet is included in the first flow, and the second notification indicating the second sequence number assigned to the first packet when the first packet is included in the second flow.

2. The relay apparatus according to claim 1, wherein
the processor is configured to
receive the first packet which is transmitted from the first communication apparatus in response to the second notification, and
transmit, to the second communication apparatus, the first packet transmitted from the first communication apparatus in response to the second notification after the third plurality of packets are transmitted to the second communication apparatus as the third flow.

3. The relay apparatus according to claim 1, wherein
the processor is configured to
store, in the memory, the third plurality of packets included in the third flow,
determine a first reception frequency of the first notification, and
when the first reception frequency is equal to or greater a first value, retransmit the first packet from the memory in response to the first notification.

4. The relay apparatus according to claim 1, wherein
the processor is configured to
receive, from the second communication apparatus, a fourth plurality of packets included in a fourth flow,
extract a fifth plurality of packets from the fourth plurality of packets,
extract a sixth plurality of packets from the fourth plurality of packets, the sixth plurality of packets being different from the fifth plurality of packets,
assign a fifth sequence number to each of the fifth plurality of packets,
assign a sixth sequence number to each of the sixth plurality of packets,
transmit, to the second communication apparatus, the fifth plurality of packets as a fifth flow, and
transmit, to the second communication apparatus, the sixth plurality of packets as a sixth flow.

5. The relay apparatus according to claim 4, wherein
a fourth sequence number is assigned to each of fourth plurality of packets, and
the processor is configured to
store, in the memory, a third correspondence relationship between the fifth sequence number and the fourth sequence number, and a fourth correspondence relationship between the sixth sequence number and the fourth sequence number,
receive at least one of a third notification and a fourth notification, the third notification indicating the fifth sequence number assigned to a second packet in the fifth flow, and the fourth notification indicating the sixth sequence number assigned to a third packet in the sixth flow,
identify the fourth sequence number of the second packet in the fourth flow when the third notification is received, and the fourth sequence number of the third packet in the fourth flow when the fourth notification is received, and
transmit, to the second communication apparatus, a fifth notification indicating the fourth sequence number in the fourth flow.

6. The relay apparatus according to claim 5, wherein
the processor is configured to
receive at least one of the second packet and the third packet from the second communication apparatus in response to the fifth notification, and
transmit, to the first communication apparatus, the at least one of the second packet and the third packet received from the second communication apparatus in response to at least one of the third notification and the fourth notification after the fourth plurality of packets and the fifth plurality of packets are transmitted to the first communication apparatus as the fifth flow and the sixth flow.

7. The relay apparatus according to claim 5, wherein
the processor is configured to
store, in the memory, the fifth plurality of packets included in the fifth flow and the sixth plurality of packets included in the sixth flow,
determine a second reception frequency of at least one of the third notification and the fourth notification, and
when the second reception frequency is equal to or greater than a second value, retransmit at least one of the second packet and the third packet from the memory in response to at least one of the third notification and the fourth notification.

8. The relay apparatus according to claim 1, wherein
the relay apparatus and the first communication apparatus communicate with each other using link aggregation, and
the second communication apparatus does not support the link aggregation.

9. The relay apparatus according to claim 1, wherein
the first flow is defined based on a first source address and a first source port number of the first plurality of packets, and the second flow is defined based on a second source address and a second source port number of the second plurality of packets.

10. A method of relaying packets executed by a relay apparatus configured to relay communication between a first communication apparatus and a second communication apparatus, the method comprising:
receiving, from the first communication apparatus, a first plurality of packets included in a first flow and a second plurality of packets included in a second flow;
transmitting, as a third flow, a third plurality of packets including the first plurality of packets and the second plurality of packets to the second communication apparatus;
storing a first correspondence relationship between a first sequence number in the first flow assigned to each of the first plurality of packets and a third sequence number in the third flow assigned to each of the third plurality of packets, and a second correspondence relationship between a second sequence number in the second flow assigned to each of the second plurality of packets and the third sequence number;
receiving, from the second communication apparatus, a first notification which requests to transmit a first packet included in the third plurality of packets, the first notification indicating the third sequence number assigned to the first packet;
determining which of the first flow and the second flow includes the first packet based on at least one of the first correspondence relationship and the second correspondence relationship; and
transmitting a second notification to the first communication apparatus, the second notification indicating the first sequence number assigned to the first packet when the first packet is included in the first flow, and the second notification indicating the second sequence number assigned to the first packet when the first packet is included in the second flow.

11. The method according to claim 10 further comprising:
receive the first packet which is transmitted from the first communication apparatus in response to the second notification; and
transmitting, to the second communication apparatus, the first packet transmitted from the first communication apparatus in response to the second notification after the third plurality of packets are transmitted to the second communication apparatus as the third flow.

12. The method according to claim 10 further comprising:
storing, in a memory, the third plurality of packets included in the third flow;
determining a first reception frequency of the first notification; and
retransmitting the first packet from the memory in response to the first notification when the first reception frequency is equal to or greater a first value.

13. The method according to claim 10 further comprising:
receiving, from the second communication apparatus, a fourth plurality of packets included in a fourth flow;
extracting a fifth plurality of packets from the fourth plurality of packets;
extracting a sixth plurality of packets from the fourth plurality of packets, the sixth plurality of packets being different from the fifth plurality of packets;
assigning a fifth sequence number to each of the fifth plurality of packets;
assigning a sixth sequence number to each of the sixth plurality of packets;
transmitting, to the second communication apparatus, the fifth plurality of packets as a fifth flow; and
transmitting, to the second communication apparatus, the sixth plurality of packets as a sixth flow.

14. The method according to claim 13, wherein
a fourth sequence number is assigned to each of fourth plurality of packets, and
the method further comprising:
storing, in the memory, a third correspondence relationship between the fifth sequence number and the fourth sequence number, and a fourth correspondence relationship between the sixth sequence number and the fourth sequence number;
receiving at least one of a third notification and a fourth notification, the third notification indicating the fifth sequence number assigned to a second packet in the fifth flow, and the fourth notification indicating the sixth sequence number assigned to a third packet in the sixth flow;
identifying the fourth sequence number of the second packet in the fourth flow when the third notification is received, and the fourth sequence number of the third packet in the fourth flow when the fourth notification is received; and
transmitting, to the second communication apparatus, a fifth notification indicating the fourth sequence number in the fourth flow.

15. The method according to claim 14 further comprising:
receiving at least one of the second packet and the third packet from the second communication apparatus in response to the fifth notification; and
transmitting, to the first communication apparatus, the at least one of the second packet and the third packet transmitted from the second communication apparatus in response to at least one of the third notification and the fourth notification after the fourth plurality of packets and the fifth plurality of packets are transmitted to the first communication apparatus as the fifth flow and the sixth flow.

16. The method according to claim 14 further comprising:
storing, in the memory, the fifth plurality of packets included in the fifth flow and the sixth plurality of packets included in the sixth flow;
determining a second reception frequency of at least one of the third notification and the fourth notification; and
retransmitting at least one of the second packet and the third packet from the memory in response to at least one of the third notification and the fourth notification when the second reception frequency is equal to or greater than a second value, retransmitting at least one of the second packet and the third packet from the memory in response to at least one of the third notification and the fourth notification.

17. The method according to claim 10, wherein
the relay apparatus and the first communication apparatus communicate with each other using a link aggregation, and
the second communication apparatus does not support the link aggregation.

18. The method according to claim 10, wherein
the first flow is defined based on a first source address and a first source port number of the first plurality of packets, and the second flow is defined based on a second source address and a second source port number of the second plurality of packets.

19. A relay apparatus configured to relay communication between a first communication apparatus and a second communication apparatus, the relay apparatus comprising:
a first plurality of ports to communicate with the first communication apparatus using link aggregation, the first plurality of ports receiving a first plurality of packets included in a first flow and a second plurality of packets included in a second flow from the first communication apparatus;
at least one second port to communicate with the second communication apparatus that does not support link aggregation, the at least one second port transmits, as a third flow, a third plurality of packets including the first plurality of packets and the second plurality of packets to the second communication apparatus;
a memory to store a first correspondence relationship between a first sequence number in the first flow assigned to each of the first plurality of packets and a third sequence number in the third flow assigned to each of the third plurality of packets, and a second correspondence relationship between a second sequence number in the second flow assigned to each of the second plurality of packets and the third sequence number; and
a processor coupled to the memory, the first plurality of ports and the at least one second port, the processor configured to
process a first notification received from the second communication apparatus which requests retransmission of a first packet included in the third plurality of packets, the first notification indicating the third sequence number assigned to the first packet,
determine which of the first flow and the second flow includes the first packet based on at least one of the first correspondence relationship and the second correspondence relationship, and
generate a second notification to be transmitted to the first communication apparatus, the second notification indicating the first sequence number assigned to the first packet when the first packet is included in the first flow, and the second notification indicating the second sequence number assigned to the first packet when the first packet is included in the second flow.
